(19) United States
(12) Patent Application Publication
(10) Pub. No.: US 2025/0018347 A1
(43) Pub. Date: Jan. 16, 2025

(54) DURABLE WATER PERMEABLE FILTRATION MEMBRANES

(71) Applicant: HYDROXSYS HOLDINGS LIMITED, Auckland (NZ)

(72) Inventors: Dylan Townshend Gifford, Hastings (NZ); Sophie Jayne Mills, Auckland (NZ); Gordon Brett Pascoe, North Hamilton (NZ); Chathuni Duleesha Ranaweera, Auckland (NZ); Walt Wheelwright, Auckland (NZ)

(21) Appl. No.: 18/828,567

(22) Filed: Sep. 9, 2024

Related U.S. Application Data
(63) Continuation-in-part of application No. 17/060,849, filed on Oct. 1, 2020, now Pat. No. 12,083,780.
Application No. 17/060,849 is a continuation-in-part of application No. PCT/IB2020/053116, filed on Apr. 1, 2020.
Application No. PCT/IB2020/053116 is a continuation-in-part of application No. PCT/IB2019/052649, filed on Apr. 1, 2019.
(63) Continuation-in-part of application No. 17/666,706, filed on Feb. 8, 2022.
Application No. 17/666,706 is a continuation-in-part of application No. PCT/IB2020/057503, filed on Aug. 10, 2020.
Application No. PCT/IB2020/057503 is a continuation-in-part of application No. PCT/IB2020/059236, filed on Oct. 2, 2020.

(30) Foreign Application Priority Data
Mar. 30, 2018 (AU) 2018901072
Apr. 1, 2019 (AU) 2019901089
Aug. 9, 2019 (AU) 2019902876
Oct. 2, 2019 (AU) 2019903701
Oct. 2, 2019 (AU) 2019903703
Apr. 1, 2020 (AU) 2020901007
Aug. 10, 2020 (AU) 2020902821

(51) Int. Cl. B01D 69/12; A23C 9/142; B01D 69/02; B01D 71/26; B01D 71/28; B01D 71/38; B01D 71/52; B01D 71/78

(52) U.S. Cl. CPC B01D 69/1214; B01D 69/02; B01D 71/261; B01D 71/281; B01D 71/381; B01D 71/5211; B01D 71/78; A23C 9/1422; B01D 2325/30; B01D 2325/36

(57) ABSTRACT

Water-wettable filtration membranes comprising a microporous sheet of a polyolefin, such as poly(ethylene), grafted with one or more preformed polymers are described. Examples where the preformed polymer is poly(4-ethenylbenzene sulfonic acid) or the poloxamer supplied under the trade name PLURONIC™ P-123 are provided. The membranes can be used in the recovery or removal of water from aqueous feed streams or the manufacture of composite membranes where a film of hydrophilic poly(ethenol) (polyvinyl alcohol; PVA) is adhered to the microporous sheet. The membranes provide the advantage of being tolerant to the cleaning agents used in clean-in-place protocols and can be used to remove particulates and solutes from these aqueous feed streams. The composite membranes are particularly suitable for use in the recovery or removal of water from feed streams in the beverage and food industries, including dairy.

### TECHNICAL FIELD

The invention relates to water permeable filtration membranes based on microporous sheets of polyolefin, filter elements comprising such membranes, and their use in recovering water from feed streams. In particular, the invention relates to water permeable filtration membranes and their use in recovering water from feed streams where periodic in situ cleaning of the membrane is required.

### BACKGROUND ART

Polyolefins, including poly(ethylene), are relatively inert, low surface energy polymers. The preparation of microporous sheets of these polymers is known. Without further treatment the microporous sheets are not readily wetted with water.

It is known to use grafting to modify the surface of substrates formed from polyolefins. For example, the publication of Tazuke and Kimura (1978) discloses photografting onto poly(propylene), poly(ethylene) and several other polymer films using benzophenone as a sensitizer. In this publication the choice of solvent and sensitizer was noted to be very important.

The publication of Ang et al (1980) discloses an irradiation procedure where the sensitizer is dissolved in the monomer solution and can be used for the photosensitized copolymerization in high yields of styrene, 4-vinyl pyridine and methyl methacrylate to poly(propylene). Again, this publication notes that the reaction was found to be very specific to certain types of sensitizers.

The publication of Ogiwara et al (1981) discloses the photografting on poly(propylene) and low-density poly(ethylene) (LDPE) films on which sensitizers were coated beforehand. The sensitizers coated on films enabled vinyl monomers, such as methyl methacrylate, acrylic acid and methacrylic acid to graft easily with high yields. The hydrophilic monomers acrylic acid and methacrylic acid were conveniently grafted using them in aqueous solution in a liquid phase system.

The publication of Allmer et al (1988) discloses the modification of surfaces of LDPE, high-density poly(ethylene) (HDPE) and polystyrene by grafting with acrylic acid. The grafting is performed in the vapor-phase and increased the wettability of the polymer. It was observed that acetone was able to initiate grafting and was found to promote and direct grafting to the surface. The later publication of Allmer et al (1989) discloses the grafting of the surface of LDPE with glycidyl acrylate and glycidyl methacrylate by photoinitiation. Acetone and ethanol were used as solvents, with acetone yielding slightly more grafting at the surface.

The publications of Yao and Ranby (1990a, 1990b and 1990c) disclose inter alia a process for the continuous photoinitiated graft copolymerization of acrylamide and acrylic acid onto the surface of HDPE tape film. The process is performed under a nitrogen atmosphere using benzophenone as the photoinitiator. It was noted that pre-soaking was very important for efficient photographing within short irradiation times. The application of this pre-soaking photografting method to poly(ethylene terephthalate) (PET) was also disclosed. In this context acetone was found to be a somewhat better solvent than methylethylketone and methylpropylketone. When applied to a continuous process for the photochemically induced graft polymerization of acrylamide and acrylic acid of poly(propylene) (PP) fibre surface under a nitrogen atmosphere, optimal concentrations of monomer and initiator in the pre-soaking solution were determined.

The publications of Kubota and Hata (1990a and 1990b) disclose an investigation of the location of methacrylic acid chains introduced into poly(ethylene) film by liquid and vapor-phase photografting and a comparative examination of the photografting behaviours of benzil, benzophenone and benzoin ethyl ether as sensitizers. In these latter studies poly(methacrylic acid) was grafted onto initiator-coated LDPE film.

The publication of Edge et al (1993) discloses the photochemical grafting of 2-hydroxyethyl methacrylate (HEMA) onto LDPE film. A solution phase method is used to produce a material with increased wettability.

The publication of Singleton et al (1993) discloses a method of making a polymeric sheet wettable by aqueous solvents and useful as an electrode separator in an electrochemical device. The polymeric sheet is formed from fibres which comprise poly(propylene) alone and is distinguished from a membrane formed from a microporous polymer sheet.

The publication of Zhang and Ranby (1993) discloses the photochemically induced graft copolymerisation of acrylamide onto the surface of PP film. Acetone was shown to be the best solvent among the three aliphatic ketones tested.

The publications of Yang and Ranby (1996a and 1996b) disclose factors affecting the photografting process, including the role of far UV radiation (200 to 300 nm). In these studies benzophenone was used as the photoinitiator and LDPE film as the substrate. Added water was shown to favour the photografting polymerisation of acrylic acid on the surface of polyolefins, but acetone was shown to have a negative effect due to the different solvation of poly(acrylic acid) (PAA).

The publication of Hirooka and Kawazu (1997) discloses alkaline separators prepared from unsaturated carboxylic acid grafted poly(ethylene)-poly(propylene) fibre sheets. Again, the sheets used as a substrate in these studies are distinguished from a membrane formed from a microporous polymer sheet.

The publication of Xu and Yang (2000) discloses a study on the mechanism of vapor-phase photografting of acrylic acid onto LDPE.

The publication of Shentu et al (2002) discloses a study of the factors, including the concentration of monomer, affecting photo-grafting on LDPE.

The publication of El Kholdi et al (2004) discloses a continuous process for the graft polymerisation of acrylic acid from monomer solutions in water onto LDPE. The publication of Bai et al (2011) discloses the preparation of a hot melt adhesive of grafted low-density poly(ethylene) (LDPE). The adhesive is prepared by surface UV photografting of acrylic acid onto the LDPE with benzophenone as the photoinitiator.

The publication of Choi et al (2001) states that graft polymerisation is considered as a general method for modifying the chemical and physical properties of polymer materials.

The publication of Choi (2002) discloses a method for producing an acrylic graft polymer on the surface of a polyolefin article comprising the steps of immersing the article in a solution of an initiator in a volatile solvent, allowing the solvent to evaporate, and then immersing the article in a solution of an acrylic monomer before subjecting the article to ultraviolet irradiation in air or an inert atmosphere. Acrylic acid is used as the acrylic monomer in each one of the Examples disclosed in the publication, although the use of equivalent amounts of methacrylic acid, acrylamide and other acrylic monomers is anticipated.

The publication of Choi (2004) discloses the use of “ethylenically unsaturated monomers” in graft polymerisation. These other monomers are disclosed as monomers that are polymerizable by addition polymerisation to a thermoplastic polymer and are hydrophilic as a consequence of containing carboxyl (—COOH), hydroxyl (—OH), sulfonyl (SO₃), sulfonic acid (—SO₃H) or carbonyl (—CO) groups. No experimental results concerning the chemical and physical properties of graft polymers prepared by a method using these other monomers is disclosed.

The publication of Choi (2005) discloses a non-woven sheet of polyolefin fibres where opposed surfaces of the sheet are hydrophilic as a consequence of an acrylic graft polymerisation. The properties of the sheet are asymmetric, the ion exchange coefficient of the two surfaces being different. The method used to prepare these asymmetric acrylic graft polymerised non-woven polyolefin sheets comprises the steps of immersing the substrates in a solution of benzophenone (a photoinitiator), drying and then immersing the substrate in a solution of acrylic acid prior to subjecting to ultraviolet (UV) irradiation. The irradiation may be performed when the surfaces are in contact with either air or an inert atmosphere.

The publication of Callis et al (2008) discloses humidifier membranes for use in fuel cells. The membranes are a microporous web of polyolefin fibrils having a hydrophilic surface. The membranes allow for the passive transfer of water between separated gasses of differing humidity. The membranes are manufactured by grafting a hydrophilic monomer to the surface of the microporous web of polyolefin fibrils. A reduction of the pore size as a consequence of the grafting process is sought. Sodium-styrene sulfonic acid (SSS; 4-ethenyl benzene sulfonic acid) is identified as one of the hydrophilic monomers that may be used in the manufacture of the membranes.

The publication of Gao et al (2013) discloses a method of preparing a radiation cross-linked lithium-ion battery separator. In an example, a porous polyethylene membrane is immersed in a solution of benzophenone and triallyl cyanurate in dichloromethane. The immersed membrane is dried at room temperature before being immersed in a water bath at 30° C. and irradiated on both sides using a high-pressure mercury lamp for three minutes.

The publication of Jaber and Gjoka (2016) discloses the grafting of ultra-high molecular weight polyethylene microporous membranes using monomers having one or more anionic, cationic or neutral groups. The publication states that the authors have discovered that molecules can be grafted on the surface of an asymmetric, porous ultra-high molecular weight polyethylene membrane using an ultraviolet radiation energy source. The grafted membranes are proposed for use in removing charged contaminants from liquids.

The objective of the majority of the foregoing prior art methods is to improve the adhesion, biocompatibility, printability or wettability of the surface of a substrate using photoinitiated polymerisation. These methods are to be distinguished from the use of UV-initiated grafting with an exogenously prepared preformed polymer to modify the permeability to water of an inherently hydrophobic microporous polyolefin substrate.

The publication of Schmolka (1973) discloses the preparation of polyoxyethylene-polyoxypropylene block polymers represented by the formula:

HO(C₂H₄O)_{b}(C₃H₆O)ₐ(C₂H₄O)_{b}H

where a is an integer such that the hydrophobic base represented by (C₃H₆O) has a molecular weight of at least 2,250 and b is an integer from about 8 to 180 or higher. These block polymers are used to prepare solid or semisolid colloids containing considerable quantities of liquid—‘gels’ or ‘hydrosols’ (where the liquid is water) that are particularly useful in the formulation of topically applicable cosmetic and pharmaceutical compositions. Referred to as poloxamers, these nonionic triblock copolymers are supplied under a number of trade names, including ACCLAIM™, ADEKANOL™, ANTAROX™, BASOROL™, BLAUNON™, ETHOX™, KOLLIPHOR™, LUTROL™, MEROXAPOL™, PLURIOL™, PLURONIC™ and SYNPERONIC™. The properties of the poloxamer are determined by both the ratio and size of the integers a and b. Triblock copolymers in which the order of the polyoxyethylene and polyoxypropylene blocks is reversed are also supplied under these trade names. These “reverse” triblock copolymers may be identified by the use of the letter “R” and should not be referred to as “poloxamers”.

The publication of Wang et al (2006) discloses the formation of membranes from blends of polyether sulfone and different triblock copolymers by a phase inversion method. Water fluxes determined for the membranes were observed to be dependent on the triblock copolymer structure rather than content. For example, the water flux (50.161 LMH) of a membrane formed from a blend with PLURONIC™ 123 was observed to be less than that (109.081 LMH) observed for the polyether sulfone control membrane. The water flux (218.28 LMH) of a membrane formed from a blend with PLURONIC™ F68 was observed to be higher than that of the control membrane.

The publication (machine translation) of Liu et al (2014) discloses the preparation of a microporous membrane with a microstructured surface for use in the separation of oil from water in oil/water emulsions. In the method of preparing the membrane polyoxyethylene-polyoxypropylene-polyoxyethylene (F127) is used as an additive in the preparation of a homogenous solution of polymer in solvent. The polymer is selected from a group consisting of polyvinylidene fluoride (PVDF), polysulfone (PSf), polyether sulfone (PES), polyacrylonitrile (PAN), polyvinyl chloride (PVC), polylactic acid (PLA), polyimide (PI), polypropylene (PP) or cellulose acetate and the solvent is selected from a group consisting of chloroform (CHCl₃), N,N-dimethyl formamide (DMF), N,N-dimethyl acetamide (DMAc), phosphoric acid triethyl ester (TEP), trimethyl phosphate (TMP), N-methyl pyrrolidone (NMP), dimethyl solfoxide (DMSO), tetrahydrofuran (THE), dibutyl phthalate (DBP), dioxane, propiophenone, diphenyl ether in one or more mixtures thereof.

The publication of Yang et al (2014) discloses a composite polymer electrolyte for use in lithium-polymer batteries. The composite was composed of mesoporous modified silica fillers dispersed in poly(vinylidene fluoride-hexafluoropropylene) matrix. The triblock copolymer PLURONIC™ 123 (Aldrich) was used in the preparation of the mesoporous silica fillers.

The publication of Guo et al (2015) discloses a microporous material used in micro- and ultrafiltration membranes. The microporous material comprises finely divided particles, such as water insoluble silica filler, distributed throughout a matrix, such as poly(ethylene). The material further comprises a network of interconnecting pores and may be further processed depending on the desired application. In such further processing triblock copolymers based on poly(ethylene oxide)-poly(propylene oxide)-poly(ethylene oxide) may be used as a hydrophilic coating, although polymers comprising tertiary amine functional groups are preferred. Without intending to be bound by theory, it is stated that components of the coating may interact with the silica particles in the fill of the microporous material and adjust the surface energy, affecting wettability. No covalent binding of the hydrophilic coating, such as that achievable by grafting, is disclosed.

The publication (machine translation) of Cheng et al (2017) discloses the use of poly(ethylene oxide)-poly(propylene oxide)-poly(ethylene oxide) triblock copolymer as a “structure directing agent” in the preparation of a mesoporous composite film. The structure directing agent is used with a catalyst and precursor compound such as tetraethyl orthosilicate, titanium tetrachloride, titanium n-butyl acetate, isopropyl titanium, phtalic acid di-zinc acetate, tin ester and one or more of niobate to provide the mesoporous composite film.

The publication of Carter et al (2018) discloses the evaluation of the triblock copolymer PLURONIC™ L64 as a solvent for pore filling regenerated cellulose membranes during initiator immobilisation. Glycerol was determined to be a more efficient pore filling solvent in this context.

The publication of Bolto et al (2009) reviews what is disclosed in publications concerning the cross-linking of poly(ethenol), i.e. PVA. These publications include those concerning cross-linking methods and the grafting of PVA onto support membranes, including porous hydrophobic membranes such as poly(ethylene) and poly(propylene).

The majority of these prior art methods are using the triblock copolymer as an aid in the preparation of membranes as opposed to an integral component.

The publication of Linder et al (1988) discloses semipermeable composite membranes comprising a film of modified PVA or PVA-copolymers on a porous support. Suitable support materials are required to be water insoluble and may be chosen, e.g. from polyacrylonitriles, polysulfones, polyamides, polyolefins such as poly(ethylenes) and poly(propylenes), or cellulosics.

The publication of Exley (2016) discloses an asymmetric composite membrane consisting of a film of cross-linked poly(ether ether ketone) adhered to a sheet of grafted microporous poly(ethylene). The microporous poly(ethylene) is obtained by photoinitiated grafting with an ethenyl monomer to provide a hydrophilicitized sheet.

The publication of Craft et al (2017) discloses improvements in the asymmetric composite membranes disclosed in the publication of Exley (2016). The improved asymmetric composite membranes comprise of poly(vinyl alcohol) polymer crosslinked with a crosslinking agent (such as divinyl benzene) coated on a film of cross-linked poly(ether ether ketone) adhered to a sheet of the grafted microporous poly(ethylene). The improvement is in the selectivity of the asymmetric composite membrane obtained.

The plant used in beverage and food processing is required to be periodically cleaned. Cleaning may be required because of fouling by non-specific adsorption or deposition of proteins, or to avoid microbial contamination of the processed beverage or food. Efficiencies in plant operation are realised if the filtration membranes can be cleaned in situ. The aqueous cleaning solutions used in these cleaning procedures are chemically aggressive (acid, caustic, hypochlorite, peroxide, etc.). After use, the spent solution, often containing particulates from the cleaning operation, is required to be disposed of incurring cost and potential harm to the environment.

The ability to recover and reuse the aqueous cleaning solutions without compromise to the efficacy of the cleaning operations would be advantageous but presents a number of challenges. Any filtration membrane used to separate particulates from the aqueous solutions must be durable, i.e. able to tolerate all the chemically aggressive cleaning solutions. Secondly, the filtration membrane must be capable of being used in a compact configuration, e.g. a spiral-wound filter element, and provide a flux sufficiently high for reuse of the cleaning solutions to be practical in a commercial setting.

It is an object of the present invention to provide asymmetric composite membranes with improved levels of protein rejection while maintaining an acceptable flux. It is an object of the present invention to provide a method for preparing the asymmetric composite membranes. It is an object of the present invention to provide a hydrophilicitized sheet of microporous polyolefin particularly suited for use in the method of preparing the asymmetric composite membrane. It is an object of the present invention to provide asymmetric composite membranes and hydrophilicitized sheets of microporous polyolefin adaptable for use in extracting or recovering water from feed streams in a variety of industries where durability of the membranes or sheets is advantageous, including beverage and food processing industries such as the dairy industry. These objects are to be read in the alternative with each other and the object at least to provide a useful choice in the selection of such methods, membranes and sheets.

### STATEMENT OF INVENTION

In a first aspect a composite membrane comprising poly(ethenol) adhered to a hydrophilicitized microporous sheet of polyolefin is provided.

A hydrophilicitized microporous sheet is one that “wets out” on contact with water under ambient conditions, i.e. without the need to apply heat or pressure. This wetting out is often observed as a change in the appearance of the microporous sheet from opaque to uniformly translucent. Desirably, the hydrophilicitized microporous sheet of polyolefin has a surface tension of at least 70 dyne/cm. The hydrophilicitized microporous sheet is composed of polyolefin grafted with a preformed polymer. The polymer may be selected from the group consisting of: poly(4-ethenyl benzene sulfonic acid) and poloxamers.

The membrane is typically an asymmetric composite membrane with the poly(ethenol) adhered predominantly to one side of the sheet. The adherence to the hydrophilicitized microporous sheet may be by the radical initiated formation of covalent bonds between the poly(ethenol) and the polyolefin, i.e. grafting. Often, the poly(ethenol) will be at least partially crosslinked in addition to being adhered to the microporous sheet.

The polyolefin can be a poly(ethylene), poly(propylene), poly(butylene) or poly(methylpentene). In certain embodiments the polyolefin is poly(ethylene) or poly(propylene).

In a first embodiment of the composite membrane the hydrophilicitized microporous sheet is composed of poly(ethylene) or poly(propylene) grafted with a preformed poly(4-ethenyl benzene sulfonic acid).

In a second embodiment of the composite membrane the hydrophilicitized microporous sheet is composed of poly(ethylene) or poly(propylene) grafted with a poloxamer of the structure:

HO(ethylene oxide)ₘ-(propylene oxide)ₙ-(ethylene oxide)ₘH

where m is in the range 15 to 25 and n is in the range 50 to 90. Ideally, the poloxamer is equivalent to the polymer supplied under the trade name PLURONIC™ P-123 (Sigma-Aldrich).

In both embodiments, the polyolefin used in the preparation of the composite membrane will most often be poly(ethylene). Embodiments of the composite membrane that are asymmetric consist essentially of a film of at least partially crosslinked poly(ethenol) adhered to a microporous sheet of poly(ethylene) where the poly(ethylene) has been grafted with a preformed poly(4-ethenyl benzene sulfonic acid), a poloxamer, or a blend thereof, before adherence of the film of at least partially crosslinked poly(ethenol).

In a second aspect a method of preparing a composite membrane is provided. The method may be adapted for the continuous or semi-continuous production of the composite membrane. The method comprises:
1) Wetting a microporous sheet of grafted polyolefin with a solution in an aqueous solvent comprising poly(ethenol) and an initiator;
2) Treating the wetted, microporous sheet to adhere the poly(ethenol) to the sheet; and then
3) Drying and washing the sheet to provide the composite membrane.

The aqueous solvent is typically water. The initiator can be a persulfate. Examples of suitable initiators are ammonium (APS) and sodium persulfate (SPS). The treating the wetted, microporous sheet can be by heating or irradiating with ultraviolet light (UV) or a combination of both. Often the treating will be by irradiating with ultraviolet light (UV) at a median wavelength of about 250 nm.

The poly(ethenol) may be crosslinked to a degree equivalent to that of the partially crosslinked poly(ethenol) provided in Vial 2 of Example 9 to that of the partially crosslinked poly(ethenol) provided in Vial 4 of Example 9. Desirably, the poly(ethenol) is crosslinked to a degree substantially equivalent to that of the partially crosslinked poly(ethenol) provided in Vial 3 of Example 9. The poly(ethenol) may be crosslinked before or after wetting the microporous sheet.

In a first embodiment of the method the polyolefin has been grafted with a preformed poly(4-ethenyl benzene sulfonic acid). The preformed poly(4-ethenyl benzene sulfonic acid) may be equivalent to that provided in the working solution prepared according to Example 1.

In a second embodiment of the method the polyolefin has been grafted with a poloxamer of the structure:

HO(ethylene oxide)ₘ-(propylene oxide)ₙ-(ethylene oxide)ₘH

where m is in the range 15 to 25 and n is in the range 50 to 90. Ideally, the poloxamer is equivalent to the polymer supplied under the trade name PLURONIC™ P-123 (Sigma-Aldrich).

Typically, one side of the sheet will be wetted with the aqueous solution and an asymmetric composite membrane will be prepared. When the polyolefin is grafted with poly(4-ethenyl benzene sulfonic acid), the poly(ethenol) is preferably crosslinked before wetting the microporous sheet. When the polyolefin is grafted with a poloxamer, the poly(ethenol) is preferably crosslinked after wetting the microporous sheet.

The polyolefin used in the preparation of the composite membrane can be a poly(ethylene), poly(propylene), poly(butylene) or poly(methylpentene). In certain embodiments the polyolefin is poly(ethylene) or poly(propylene). Often the polyolefin will be poly(ethylene).

The drying of the contacted sheet may be by applying a thermal gradient across the thickness of the sheet from the contacted one side of the hydrophilicitized microporous sheet to the other side. Applying heat may be used to control the degree of hydrophilicity of the microporous sheet when the polyolefin is grafted with a poloxamer.

An asymmetric composite membrane capable of providing at least 99.9% total protein rejection at a flux of 5 LMH with milk as a feed stream can be provided.

In a third aspect a water-wettable filtration membrane comprising a poloxamer adhered to a substrate consisting of a microporous sheet of polyolefin is provided. The poloxamer is adhered to a preformed microporous sheet of the polyolefin. The poloxamer is adhered to the polyolefin matrix of the preformed microporous sheet by the formation of covalent bonds between the two polymers. The covalent bonds may be formed directly between the poloxamer and the polyolefin or indirectly via a crosslinking agent.

Preferably, the poloxamer is adhered to the matrix by grafting. Most preferably, the poloxamer is adhered to the matrix by photoinitiated grafting. In this context, the photoinitiated grafting will be understood to encompass the formation of covalent bonds initiated by irradiation with ultraviolet (UV) light, preferably UVC light, in the presence of a suitable photoinitiator. Suitable photoinitiators are type II photoinitiators such as benzophenone (diphenylmethanone; BP). The photoinitiated grafting is advantageously performed in the presence of a crosslinking agent. Suitable crosslinking agents are low molecular weight diethenyl compounds. Low molecular weight diethenyl compounds are those with a molecular weight below 150 g mol⁻¹, such as divinylbenzene (DVB).

Preferably, the poloxamer is a polymer of the structure

HO(ethylene oxide)ₘ-(propylene oxide)ₙ-(ethylene oxide)ₘH

where m is in the range 15 to 25 and n is in the range 50 to 90. Most preferably, the poloxamer is equivalent to the triblock copolymer supplied under the trade name PLURONIC™ P-123 (Sigma-Aldrich). It is understood that m is 20 and n is 70 for the polymer sold under the trade name PLURONIC™ P-123 (Sigma-Aldrich).

Preferably, the polyolefin is poly(ethylene) or poly(propylene). More preferably, the polyolefin is poly(ethylene). Most preferably, the polyolefin is a virgin poly(ethylene).

In a first embodiment of the third aspect a water-wettable filtration membrane consisting of a microporous sheet of grafted poly(ethylene) is provided where the graft comprises a poloxamer of the structure:

HO(ethylene oxide)ₘ-(propylene oxide)ₙ-(ethylene oxide)ₘH

where m is in the range 15 to 25 and n is in the range 50 to 90.

In a second embodiment of the third aspect a water-wettable filtration membrane consisting of a microporous sheet of grafted poly(ethylene) is provided where the graft comprises divinylbenzene and a poloxamer of the structure:

HO(ethylene oxide)ₘ-(propylene oxide)ₙ-(ethylene oxide)ₘH

where m is in the range 15 to 25 and n is in the range 50 to 90.

In a fourth aspect a water-wettable filtration membrane comprising a microporous sheet of grafted polyolefin is provided where the polyolefin is grafted with a blend of preformed polymers comprising a poloxamer of the structure:

HO(ethylene oxide)ₘ-(propylene oxide)ₙ-(ethylene oxide)ₘH

where m is in the range 15 to 25 and n is in the range 50 to 90.

Preferably, the blend of preformed polymers comprises the poloxamer and poly(4-ethenyl benzene sulfonic acid).

Preferably, the blend of preformed polymers is adhered to the matrix by grafting. Most preferably, the blend of preformed polymers is adhered to the matrix by photoinitiated grafting. In this context, the photoinitiated grafting will be understood to encompass the formation of covalent bonds initiated by irradiation with ultraviolet (UV) light, preferably UVC light, in the presence of a suitable photoinitiator. Suitable photoinitiators are type II photoinitiators such as benzophenone (diphenylmethanone; BP). The photoinitiated grafting is advantageously performed in the presence of a crosslinking agent. Suitable crosslinking agents are low molecular weight diethenyl compounds. Low molecular weight diethenyl compounds are those with a molecular weight below 150 g mol⁻¹, such as divinylbenzene (DVB).

Preferably, the blend of preformed polymers comprises a poloxamer of the structure

HO(ethylene oxide)ₘ-(propylene oxide)ₙ-(ethylene oxide)ₘH

where m is in the range 15 to 25 and n is in the range 50 to 90. Most preferably, the poloxamer is equivalent to the triblock copolymer supplied under the trade name PLURONIC™ P-123 (Sigma-Aldrich). It is understood that m is 20 and n is 70 for the polymer sold under the trade name PLURONIC™ P-123 (Sigma-Aldrich).

Preferably, the polyolefin is poly(ethylene) or poly(propylene). More preferably, the polyolefin is poly(ethylene). Most preferably, the polyolefin is a virgin poly(ethylene).

In a first embodiment of the fourth aspect a water-wettable filtration membrane consisting of a microporous sheet of grafted poly(ethylene) is provided where the graft consists of a blend of preformed polymers comprising a poloxamer of the structure:

HO(ethylene oxide)ₘ-(propylene oxide)ₙ-(ethylene oxide)ₘH

where m is in the range 15 to 25 and n is in the range 50 to 90.

In a second embodiment of the fourth aspect a water-wettable filtration membrane consisting of a microporous sheet of grafted poly(ethylene) is provided where the graft consists of divinylbenzene and a blend of preformed polymers comprising a poloxamer of the structure:

HO(ethylene oxide)ₘ-(propylene oxide)ₙ-(ethylene oxide)ₘH

where m is in the range 15 to 25 and n is in the range 50 to 90.

It is anticipated that poly(propylene) may be substituted for poly(ethylene) in either of the first or second embodiments of the third or fourth aspects.

Preferably, the filtration membrane of the third or fourth aspects is capable of separating micro-dimensioned particulates from an aqueous carrier. The micro-dimensioned particulates may be of abiotic or biotic origin, including bacterial cells. More preferably, the membranes of the third or fourth aspects provide for a flux of the aqueous carrier of greater than 25 LMH at a pressure of 5 bar. Most preferably, the aqueous carrier is a used cleaning solution.

Preferably, the filtration membranes of the third or fourth aspects are semipermeable membranes.

In a fifth aspect a composite membrane comprising a film of at least partially crosslinked poly(ethenol) adhered to a hydrophilicitized microporous sheet of polyolefin is provided. Preferably, the polyolefin of the hydrophilicitized microporous sheet has been grafted with a preformed poly(4-ethenyl benzene sulfonic acid) or a poloxamer or a blend thereof before adherence of the film of poly(ethenol). More preferably, the polyolefin of the hydrophilicitized microporous sheet has been grafted with a poloxamer or a blend thereof before adherence of the film of poly(ethenol). Yet more preferably, the polyolefin of the hydrophilicitized microporous sheet has been grafted with a poloxamer of the structure:

HO(ethylene oxide)ₘ-(propylene oxide)ₙ-(ethylene oxide)ₘH

where m is in the range 15 to 25 and n is in the range 50 to 90. Most preferably, the poloxamer is equivalent to the polymer sold under the trade name PLURONIC™ P-123 (Sigma-Aldrich).

Preferably, the polyolefin is selected from the group consisting of: poly(ethylene), poly(propylene), poly(butylene) and poly(methylpentene). More preferably, the polyolefin is poly(ethylene) or poly(propylene). Most preferably, the polyolefin is poly(ethylene).

In a first embodiment of the fifth aspect, a composite membrane consisting essentially of a film of at least partially crosslinked poly(ethenol) adhered to a microporous sheet of polyolefin grafted with a poloxamer is provided.

In a second embodiment of the fifth aspect, a composite membrane consisting essentially of a film of at least partially crosslinked poly(ethenol) adhered to a microporous sheet of poly(ethylene) grafted with a poloxamer equivalent to the polymer sold under the trade name PLURONIC™ P-123 (Sigma-Aldrich) is provided.

Preferably, the composite membrane is an asymmetric composite membrane.

In a sixth aspect a method of preparing a water-wettable filtration membrane is provided, where the method comprises:
1. Contacting a microporous sheet of polyolefin with a solution in a solvent comprising a poloxamer to provide a contacted sheet;
2. Irradiating the contacted sheet with ultraviolet light in the presence of a photoinitiator to provide an irradiated sheet; and then
3. Washing and drying the irradiated sheet to provide the membrane.

Preferably, the polyolefin is poly(ethylene) or poly(propylene). More preferably, the polyolefin is poly(ethylene). Most preferably, the polyolefin is virgin poly(ethylene).

Preferably, the solution comprises the photoinitiator. More preferably, the solution additionally comprises a crosslinking agent.

Preferably, the poloxamer is a polymer of the structure

HO(ethylene oxide)ₘ-(propylene oxide)ₙ-(ethylene oxide)ₘH

where m is in the range 15 to 25 and n is in the range 50 to 90. Most preferably, the poloxamer is equivalent to the triblock copolymer supplied under the trade name PLURONIC™ P-123 (Sigma-Aldrich). It is understood that m is 20 and n is 70 for the polymer sold under the trade name PLURONIC™ P-123 (Sigma-Aldrich).

Preferably, the solvent is water-alcohol or water-acetone where the ratio (v/v) of water to the alcohol or acetone is in the range 1:1 to 3:1. More preferably, the ratio (v/v) of water to the alcohol or acetone is in the range 1:1 to 2:1. Most preferably, the solvent is water-ethanol.

Preferably, the photoinitiator is a Type II photoinitiator. Most preferably, the photoinitiator is benzophenone (diphenylmethanone; BP).

Preferably, the crosslinking agent is a diethenyl compound with a molecular weight below 150 g mol⁻¹. Most preferably, the crosslinking agent is divinylbenzene (DVB).

Preferably, the ultraviolet light is UVC light. Preferably, the wavelength of the ultraviolet light is centred in the range 250 to 360 nm. More preferably, the wavelength of the ultraviolet light is centred in the range 250 to 280 nm. Most preferably, the wavelength of the ultraviolet light is centred at 250 nm.

Preferably, the irradiating is for a period of time between one and a half minutes and two and a half minutes. More preferably, the irradiating is for a period of time of two minutes plus or minus 10 seconds.

In an embodiment of the sixth aspect a method of preparing a water wettable membrane is provided, the method comprising irradiating at a wavelength centred at 250 nm a microporous sheet of poly(ethylene) impregnated with a solution in 30 to 50% (v/v) ethanol in water of 3 to 5% (w/v) of the poloxamer supplied as PLURONIC™ P-123, 0.5 to 1% (w/v) benzophenone, and 0 to 0.5% (w/v) divinylbenzene.

It is anticipated that poly(propylene) may be substituted for poly(ethylene) in this embodiment of the fourth aspect.

In a seventh aspect a method of preparing a composite membrane is provided, the method comprising the steps of:
1. Contacting in the presence of a radical initiator:
   a solution in a first solvent of poly(ethenol), and
   a hydrophilicitized microporous sheet of the third or fourth aspects,
   to provide a contacted sheet;
2. Irradiating the contacted sheet with ultraviolet light to provide an irradiated sheet;
3. Drying the irradiated sheet to provide a dried sheet; and then
4. Washing the dried sheet in a second solvent to provide the composite membrane.

Preferably, the hydrophilicitized microporous sheet of the third or fourth aspect will be a hydrophilicitized microporous sheet of polyolefin where the polyolefin has been grafted with a poloxamer or a blend of preformed polymers comprising a poloxamer.

Preferably, the first solvent is water-alcohol or water.

Preferably, the second solvent is water.

Preferably, the drying of the contacted sheet will be by applying a positive thermal gradient across the thickness of the sheet from the contacted one side of the hydrophilicitized microporous sheet to the other side.

Preferably, the composite membrane is an asymmetric composite membrane.

In an eighth aspect a method of removing particulates from an aqueous feed stream is provided, the method comprising contacting a first side of a filtration membrane of the third or fourth aspects with the feed stream at a pressure sufficient to provide a permeate.

Preferably, the feed stream is selected from the group consisting of: cleaning solutions and waste water. More preferably, the feed stream is selected from the group consisting of: caustic cleaning solution, citric acid cleaning solution and hypochlorite cleaning solution.

The particulates may be micro-dimensioned. The particulates may be of abiotic or biotic origin, including bacterial cells. Preferably, the pressure is less than 10 bar. Preferably, the filtration membrane is in the form of a spiral wound filtration membrane assembly or filter element.

In a ninth aspect the invention provides a spiral wound filtration membrane assembly or filter element comprising a membrane of the third, fourth or fifth aspects.

In the description and claims of this specification the following abbreviations, acronyms, phrases and terms have the meaning provided: “block” means portion of a macromolecule comprising many constitutional units, that has at least one constitutional or configurational feature which is not present in the adjacent portions; “CAS RN” means Chemical Abstracts Service (CAS, Columbus, Ohio) Registry Number; “comprising” means “including”, “containing” or “characterized by” and does not exclude any additional element, ingredient or step; “consisting essentially of” means excluding any element, ingredient or step that is a material limitation; “consisting of” means excluding any element, ingredient or step not specified except for impurities and other incidentals; “crosslinking agent” means a material that is incorporated into the crosslinking bridge of a cross-linked polymer network; “crosslinking” means a reaction involving sites or groups on existing macromolecules or an interaction between existing macromolecules that results in the formation of a small region, such as a crosslinking bridge, in a macromolecule from which at least four chains emanate; “curing” means chemical process of converting a prepolymer or a polymer into a polymer of higher molecular mass and connectivity and finally into a network; “filter” means to remove particles from a fluid by passing through a porous substrate and “filtration” has a corresponding meaning; “flux” means the rate (volume per unit of time) of permeate transported per unit of membrane area; “graft molecule” or “graft polymer molecule” means a macromolecule with one or more species of block connected to the main chain as side chains having constitutional or configurational features that differ from those in the main chains; “graft polymer” means a polymer in which the linear main chain has attached to it at various points side chains of a structure different from the main chain; “grafting” means a reaction in which one or more species of block are connected to the main chain of a macromolecule by side chains having constitutional configurational features that differ from those in the main chain and “grafted” has a corresponding meaning; “homopolymer” means a polymer formed by the polymerization of a single monomer; “hydrophilic” means having a tendency to mix with, dissolve in, or be wetted by water and “hydrophilicity”, “hydrophilicitized” and “hydrophilicitizing” have a corresponding meaning; “impregnating” means permeating a substrate, e.g. with a solution of reagents in a solvent; “initiator” means a labile compound which forms a radical; “LMH” means litres per hour per square metre; “macromolecule” or “polymer molecule” means a molecule of high relative molecular mass, the structure of which essentially comprises the multiple repetition of units derived, actually or conceptually, from molecules of low relative molecular mass; “macromonomer molecule” means a macromolecule that has one end-group which enables it to act as a monomer molecule, contributing only a single monomeric unit to a chain of the final macromolecule; “micro-dimensioned” means having a dimension as low as 0.5 micron; “microporous” means consisting of an essentially continuous matrix structure containing substantially uniform small pores or channels throughout the body of the substrate (such as may be manufactured using a cast (wet) process technology) and specifically excludes a discontinuous matrix of woven or non-woven fibres; “microporous” means having a median pore diameter less than 20 nm; “monomer molecule” means a molecule which can undergo polymerisation, thereby contributing constitutional units to the essential structure of a macromolecule; “monomeric unit”, “monomer unit” or “mer” means the largest constitutional unit contributed by a single monomer molecule to the structure of a macromolecule; “partially crosslinked” means that only a portion of the available sites for cross-linking are utilised and the cross-linking reaction has been limited by reagents, temperature or period of time; “permeable” means allowing the passage of a solvent, e.g. water; “permeate” means to spread throughout; “photoinitiator” means a photolabile compound which upon irradiation forms a radical; “poloxamer” means a symmetrical non-ionic triblock copolymer composed of a central chain of poly(propylene oxide) flanked by two chains of poly(ethylene oxide); “poly(ethenol)” and “polyvinyl alcohol” are used synonymously; “post-treated polymer” means a polymer that is modified, either partially or completely, after the basic polymer backbone has been formed; “preformed” means formed beforehand, i.e. prior to treatment or use; “PSSS” or “pSSS” denotes the product of the polymerization of SSS, i.e. poly(4-ethenylbenzenesulfonic acid); “PVA” denotes poly(ethenol) (or polyvinyl alcohol); “semipermeable” means allowing certain substances to pass through, but not others, especially allowing the passage of a solvent, e.g. water, but not of certain solutes, e.g. proteins, salts or sugars; “SSS” denotes sodium styrene sulfonate, i.e. the sodium salt of 4-ethenylbenzenesulfonic acid; “UVA” means electromagnetic radiation having wavelengths between 320 and 400 nm; “UVB” means electromagnetic radiation having wavelengths between 290 and 320 nm; “UVC” means electromagnetic radiation having wavelengths between 200 and 290 nm; “water-wettable” means wettable with water; “wettable” means becoming permeated with solvent, e.g. water, on being contacted with the solvent under standard laboratory conditions (i.e. 25° C. at 100 kPa); and “xPVA” denotes PVA that is at least partially crosslinked.

A paronym of any of the defined terms has a corresponding meaning. Where there is uncertainty in respect of the meaning of an undefined abbreviation, acronym, phrase or term relating to polymer terminology and nomenclature the meaning provided in the publication of Jones et al (2008) is to take precedence.

The terms “first”, “second”, “third”, etc. used with reference to elements, features or integers of the subject matter defined in the Statement of Invention and Claims, or when used with reference to alternative embodiments of the invention are not intended to imply an order of preference.

The numbering of the Examples and the Comparative Examples (if any) is not intended to mean any pair of Example and Comparative Example is directly comparable.

Where values are expressed to one or more decimal places standard rounding applies. For example, 1.7 encompasses the range 1.650 recurring to 1.749 recurring.

Where concentrations or ratios of reagents or solvents are specified, the concentration or ratio specified is the initial concentration or ratio of the reagents or solvents. Similarly, where a pH or pH range is specified the pH or range specified is the initial pH or pH range.

References to the use of 4-ethenylbenzenesulfonic acid encompass references to the use of salts of the acid, including SSS. It is understood that m is 20 and n is 70 for the polymer supplied under the trade name PLURONIC™ P-123 (Sigma-Aldrich).

It is understood that the microporous sheets supplied as TARGRAY™ wet process polyethylene separators have a median pore diameter less than 20 nm. Notwithstanding this understanding it is recognised that the porosity determined for a substrate will depend at least in part on the method employed to determine the porosity. In the present description the term “microporous” is being used to refer to the porosity of a sheet of polyolefin that is equivalent to the porosity of TARGRAY™ wet process polyethylene separators, item no. SW320H (Targray, Kirkland QC, Canada). In this context the term “equivalent” means the porosity determined for the sheet of polyolefin is 75 to 125% of the porosity determined for TARGRAY™ wet process polyethylene separators, item no. SW320H (Targray, Kirkland QC, Canada) by the same method.

In the absence of further limitation, the use of plain bonds in the representations (if used) of the structures of compounds encompasses the diastereoisomers, enantiomers and mixtures thereof of the compounds.

The invention will now be described with reference to embodiments or examples and the figures of the accompanying drawings pages. In the Brief Description of Drawings and elsewhere in the following description, reference to the “top” (Ctop, Etop, etc.) of a membrane refers to the face or side of the membrane or sheet with which the working solution is contacted. Reference to the “back” (etc.) or “backing layer” refers to the opposite face or side. It will be understood that due to the mounting of the membrane or sheet in the filtration membrane assembly the entire face or side is not exposed to the feed stream. A description of this filtration membrane assembly (Sterlitech Corp.) and its use is provided at page 24, line 24 onwards of the specification accompanying international application no. PCT/NZ2015/050034 [publ. no. WO 2015/147657 A1] (Briggs et al (2015)).

### BRIEF DESCRIPTION OF DRAWINGS

FIG. 1. Exploded view of the filter assembly (Sterlitech Corp.) used in the flux testing of samples of composite membranes and hydrophilicitized microporous sheets.

FIG. 2. FTIR spectra of the monomer 4-ethenylbenzenesulfonic acid (SSS) and poly(4-ethenylbenzenesulfonic acid) (PSSS) prepared according to the method described in Example 1 (water) and Example 2 (DMSO).

FIG. 3. FTIR spectra recorded for poly(4-ethenylbenzenesulfonic acid) (PSSS), the photoinitiator benzophenone (BP), no washing protocol (1), washed with water at a temperature of 45 to 50° C. before drying (2), washed with acetone (3) and washed with water at a temperature of 45 to 50° C., dried and then washed with acetone (4).

FIG. 4. Photograph of vials containing partially crosslinked poly(ethenol) (xPVA) prepared according the Example 8. From left to right: Vial 1, Vial 2, Vial 3 and Vial 4.

FIG. 5. Flux (LMH) (♦, broken line), total solids (%) (▴, dotted line) and protein rejection (%) (▪, solid line) of a sample of an composite membrane (030918Sii) prepared according to Example 10 during repeated clean-in-place (C-i-P) protocols.

FIG. 6. Pressure series testing (0 to 20 bar) of a sample (030918Siii) of a composite membrane prepared according to Example 10. Flux and protein rejection with milk as the feed stream were measured.

FIG. 7. Comparison of the FTIR spectra (full range) recorded for samples (240818Si and 240818Sii) of a composite membrane prepared according to Example 10 and the poly(ethenol) (PVA) and cross-linked poly(ethenol) (xPVA) used in their preparation.

FIG. 8. Comparison of the FTIR spectra (stretch mode region) recorded for samples (240818Si and 240818Sii) of a composite membrane prepared according to Example 10 and the poly(ethenol) (PVA) and cross-linked poly(ethenol) (xPVA) used in their preparation.

FIG. 9. Comparison of the FTIR spectra (fingerprint region) recorded for samples (240818Si and 240818Sii) of a composite membrane prepared according to Example 10 and the poly(ethenol) (PVA) and cross-linked poly(ethenol) (xPVA) used in their preparation.

FIG. 10. Scanning electron micrographs of the surface of samples of composite membrane prepared according to Example 10 before (A) and after (B) being subjected to repeated clean-in-place (CIP) protocols.

FIG. 11. A comparison of the spectra (3800 cm⁻¹ to 525 cm⁻¹) recorded for the untreated microporous poly(ethylene) (TARGRAY™ wet process polyethylene separators, item no. SW320H (Targray, Kirkland QC, Canada)) (PE virgin) and the triblock copolymer (PLURONIC™ P-123; lot #MKCC2305, Sigma-Aldrich) (P123) used in the preparation of the samples, and the top (Etop) and back (Eback) side of each of the samples designated 040918Wiv, 040918Wv and 040918Wvi.

FIG. 12. A comparison of the spectra from FIG. 11 expanded over the ‘fingerprint region’ (1800 cm⁻¹ to 600 cm⁻¹).

FIG. 13. A comparison of the spectra (3800 cm⁻¹ to 525 cm⁻¹) recorded for regions of the sample designated 040918Wvi with (Ctop and Cback) and without (Etop and Eback) exposure to the feed stream.

FIG. 14. Scanning electron micrographs of the top (Etop) side of the sample designated 040918Wiv at magnifications of 250,000× (A), 35,000× (B) and 10,000× (C).

FIG. 15. Scanning electron micrographs of two regions of the top (Etop) side the sample designated 040918Wiv at a magnification of 100,000×.

FIG. 16. Comparison of the flux (LMH) maintained for samples of filtration membrane (180419Wi and 230419Wii (▪); 180419Wii and 230419Wiii (●)) prepared with (solid line) and without (broken line) a crosslinking agent (DVB).

FIG. 17. Schematic representation of the prototype production line used in the preparation of the water-wettable filtration membrane according to Example C.

FIG. 18. Photograph of bottles containing samples of used caustic cleaning solution (left bottle) and permeate (right bottle) following filtration of the used caustic cleaning solution as described in Example E.

FIG. 19. Plot of flow rate (litres/minute) at each of the two inlets (solid and broken lines) of the rate versus reading (seconds) on time during filtration of the used caustic cleaning solution shown in FIG. 18 (left bottle).

FIG. 20. Plot of flow rate (litres/minute) of the permeate shown in FIG. 18 (right bottle) versus reading (seconds) on timer during filtration of used caustic cleaning solution.

FIG. 21. Photograph of bottle containing samples of less pigmented used caustic cleaning solution (left bottle) and permeate (right bottle) following filtration of the used caustic cleaning solution as described in Example E.

FIG. 22. Plot of flow rate (litres/minute) of the permeate shown in FIG. 12 (right bottle) versus reading (seconds) on timer showing filtration of the less pigmented used caustic cleaning solution.

FIG. 23. Photograph of bottles containing samples of heavily contaminated, i.e. high solids, used caustic cleaning solution (left and middle bottles) and permeate (right bottle) following filtration of the used caustic cleaning solution as described in Example E.

FIG. 24. Photograph of bottles containing samples of used citric acid cleaning solution (left bottle) and permeate (middle bottle) and concentrate i.e. retentate (right bottle) following filtration of the used citric acid cleaning solution.

FIG. 25. Plot of flow rate (litres/minute) of the permeate shown in FIG. 24 (middle bottle) versus reading (seconds) on time during filtration of the used citric acid cleaning solution.

FIG. 26. Appearance of a volume of 10 mL of working solution prepared according to methods 1, 2 and 3 of EXAMPLE G. ‘Working solution A’ contains a quantity of 0.15 g poly(ethenol) (PVA, 65 kDa). ‘Working solution B’ contains a quantity of 0.25 g poly(ethenol) (PVA, 65 kDa). The turbid ‘working solution C’ contains a quantity of 0.5 g poly(ethenol) (PVA, 65 kDa).

FIG. 27. Appearance of the replicate samples prepared according to method 6 of EXAMPLE G and designated 041918wi, 041918wii and 041918wiii.

FIG. 28. A comparison of the spectra (3800 cm⁻¹ to 525 cm⁻¹) recorded for the untreated microporous poly(ethylene) (TARGRAY™ wet process polyethylene separators, item no. SW320H (Targray, Kirkland QC, Canada)) (PE virgin), the triblock copolymer (PLURONIC™ P-123; lot #MKCC2305, Sigma-Aldrich) (P123) and poly(ethenol) (PVA, 65 kDa) (PVA65) used in the preparation of the samples, and the centre (-C) and edge (-E) of each of the samples designated 310818wi, 030918wii and 030918wi.

FIG. 29. A comparison of the spectra expanded over the ‘fingerprint region’ (1800 cm⁻¹ to 600 cm⁻¹) recorded for the untreated microporous poly(ethylene) (TARGRAY™ wet process polyethylene separators, item no. SW320H (Targray, Kirkland QC, Canada)) (PE virgin), the triblock copolymer (PLURONIC™ P-123; lot #MKCC2305, Sigma-Aldrich) (P123) and poly(ethenol) (PVA, 65 kDa) (PVA65) used in the preparation of the samples, and the centre (-C) and edge (-E) of each of the samples designated 310818wi, 030918wii and 030918wi.

FIG. 30. Photograph of vials containing partially crosslinked poly(ethenol) (xPVA) prepared according to method 2 of EXAMPLE H. From left to right: Vial 1, Vial 2, Vial 3 and Vial 4.

### DETAILED DESCRIPTION

Filtration membranes are used in a range of industrial processes, including food processing, to recover or remove water from a feed stream. In one application the objective may be to separate the water from contaminating particulates. In another application the objective may be to concentrate high value solutes. In either application efficiency is increased by contacting the feed stream with a large surface area of the filter membrane. To this end the filtration membrane will often be assembled into a spiral wound filter element, which is then installed in the industrial plant. Such spiral wound membrane assemblies—or “filter elements”—are supplied by manufacturers such as Synder Filtration (Vacaville, California, USA).

Further efficiencies are realised if cleaning can be performed in place without the need for removal and reinstallation of the filter element. Clean-in-place protocols use chemically aggressive solutions such as acid, alkali and hypochlorite. Alternatively, the feed streams to which the membrane is exposed may be chemically aggressive and durability under these conditions reduces the frequency with which the filter element needs to be replaced.

Microporous sheets of polyolefin, such as poly(ethylene) are available commercially from suppliers such as Celgard (Charlotte, North Carolina, USA) and Targray (Kirkland, Quebec, Canada). One impediment to the use of these substrates as filtration membranes in the applications alluded to above is there inherent hydrophobicity. Where the objective is to provide a semipermeable membrane for use in concentrating high value solutes the required rejection properties may also be lacking.

In contrast with polyolefins, poly(ethenol) (polyvinyl alcohol; PVA) is inherently hydrophilic and water soluble. The incompatible properties of the two polymers present an obstacle to the preparation of composite membranes consisting of poly(ethenol) adhered, e.g. by photoinitiated grafting, to a polyolefin substrate, such as a microporous sheet. The obstacle may be overcome by modification of the surface of the substrate to increase its hydrophilicity, i.e. wettability. It has been found that wettable, microporous sheets of polyolefin suitable for use in the manufacture of composite membranes comprising poly(ethenol) can be prepared by grafting the polyolefin substrate with certain preformed polymers. The use of the preformed polymers demonstrated here allows for the preparation of microporous sheets of polyolefin with differing degrees of hydrophilicity. Along with the selection of solvent, the degree of hydrophilicity can be used to control the extent to which the solution of poly(ethenol) permeates the microporous sheet of polyolefin during the preparation of the composite membranes. Such control can be advantageous for the continuous production of composite membranes. The use of microporous sheets of polyolefin grafted with a poloxamer is particularly advantageous as the degree of hydrophilicity imparted by these thermoresponsive polymers can additionally be controlled by temperature.

Providing a hydrophilicitized, i.e. wettable, microporous sheet of polyolefin facilitates the formation of a film of at least partially crosslinked poly(ethenol) (xPVA) on the surface and adherence to that surface. In contrast with the preparation of the asymmetric composite membranes disclosed in the publication of Craft et al (2017) persulfate is used as an agent to promote cross-linking. The high levels of protein rejection demonstrated for these composite membranes is attributed in part to the selection of this crosslinking agent. A porosity providing a size exclusion reduced to an estimated 30 kDa from an estimated 160 kDa is believed to be achieved (and is supported by the increased levels of total protein rejection of greater than 99.9%).

When drying the hydrophilicitized microporous sheet of polyolefin following contact with the dispersion in aqueous solvent of poly(ethenol) (PVA) applying a thermal gradient across the thickness of the sheet from the contacted side to the other side is also believed to assist in maintaining the porosity of the sheet and thereby provide a composite membrane with higher flux rates than might otherwise be achievable. In Example 10 the application of a positive thermal gradient is a consequence of the sheet being supported on a glass plate during the drying steps. The positive thermal gradient is believed to limit the extent to which the dispersion in water may permeate the pores of the hydrophilicitized microporous sheet.

The grafting of a microporous sheet of poly(ethylene) with a preformed polymer such as the poloxamer supplied under the trade name PLURONIC-P123 provides a filtration membrane that is readily wetted with water and provides high flux rates at relatively low pressures (5 bar). The filtration membranes so produced have also been demonstrated to have the desired durability when exposed to chemically aggressive liquids. The retention of these desirable properties—attributable to the graft—is enhanced by the inclusion of a crosslinking agent in the working solution used in the method of preparation. Without wishing to be bound by theory low molecular weight crosslinking agents are favoured so as not to disrupt the favourable rejection properties also demonstrated for the membranes.

The method of preparing the filtration membrane is readily adaptable to a continuous production process. In accordance with the methods described, working solutions of the following composition are used to impregnate the microporous substrate before it is irradiated with ultraviolet light at a wavelength in the range 250 nm to 360 nm, wavelengths at or toward the lower end of this range (250 nm) being preferred.
Working solution:
3 to 5% (w/v) poloxamer
0.5 to 1% (w/v) photoinitiator
0 to 0.5% (w/v) crosslinking agent
30 to 50% (v/v) in alcohol or acetone in water (‘solvent’)

The preferred poloxamer for use in the working solution is that supplied under the trade name PLURONIC P-123. The preferred photoinitiator for use in the working solution is benzophenone. The preferred crosslinking agent for use in the working solution is divinylbenzene.

The working solution may additionally comprise a second preformed polymer dispersed in the solvent. A suitable second preformed polymer is poly(ethanol). The inclusion of a second preformed polymer may be used to refine the properties (durability, flux or selectivity) of the filtration membrane.

When the hydrophilicitized microporous sheet of polyolefin has been prepared using a poloxamer, as in Example 12, heating transiently alters the degree of hydrophilicity imparted by the graft. This phenomenon may also be utilised to promote formation of a thin film of poly(ethenol) at the surface of the sheet without loss of porosity of the substrate. The transient decrease in hydrophilicity favours exclusion of the aqueous solvent from the pores of the substrate.

The composite membranes provided here are distinguished from other membranes, e.g. those suggested in the publication of Linder et al (1988), where a superficial film of cross-linked PVA or PVA-copolymer is proposed to be coated on a hydrophobic, i.e. water repelling, microporous sheet of polyolefin.

### Materials and Methods

All microporous sheets of polyolefin used in the preparation of samples were prepared from virgin poly(ethylene), i.e. poly(ethylene) of high purity.

### FTIR

Spectra of the samples were recorded using a Thermo Electron Nicolet 8700 FTIR spectrometer equipped with a single bounce ATR and diamond crystal. An average of 32 scans with a 4 cm⁻¹ resolution was taken for all samples.

### Flux

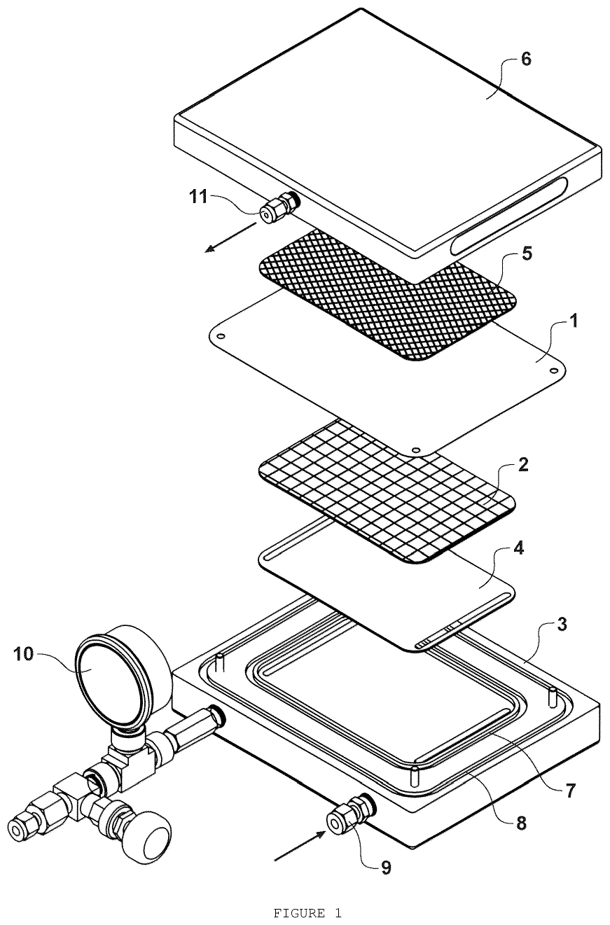

Permeability was determined using a filter assembly (Sterlitech Corp.) (FIG. 1) by measuring the flux with deionized water as the feed stream at various pressures. Flux Jᵥwas then graphed against effective pressure difference across the membrane, P_{eff}, and the slope of the permeability Lₚ.

$${L}_{p} = \frac{{J}_{V}}{Δ {p}_{eff}}$$

The samples were mounted in the filter assembly. Deionized water was fed into the rig at 2.5 L min⁻¹ and 4 to 8° C. The time to collect a predetermined volume of permeate was noted. The flux rate (J) was calculated according to the following equation:

$$J = \frac{V}{t \times A}$$

where V is the permeate volume (L), t is the time (h) for the collection of V and A is area of the sample (m²) which was determined to be 0.014 m².

### Salt Rejection

Rejection was measured using a 2 g/L solution in water of sodium chloride with a feed pressure of 16 bar. The conductivities from the feed and permeate were compared.

$$\% {R}_{NaCl} = ( 1 - \frac{{σ}_{p}}{{σ}_{f}} ) \times 100$$

where σₚ is the conductivity of permeate and σ_{f} is the conductivity of the feed.

### Total Solids Rejection

Rejection for whole milk samples was measured by pouring 20 mL of sample from the feed in a petri dish and measuring the dry weight after 2 hours in a 100° C. oven.

$$\% {R}_{TS} = ( 1 - \frac{{m}_{p , TS}}{{m}_{f , TS}} ) \times 100$$

where m_{p,TS} is total milk solids in the permeate and m_{f,TS} is the mass of milk total solids in the feed.

### Protein Concentrations

Total protein and total whey protein concentrations in permeate were calculated on the basis of HPLC analysis with UV absorbance monitoring.

### ‘Clean-In-Place’ (CIP) Protocol

To mimic commercial processing operations samples of the composite membrane was subjected to repeated in situ washing protocols) as described in Craft et al (2017). The intermediate and subsequent flux rates were determined to assess the likely durability of the membrane in commercial processing operations. The in situ washing protocol was based on that employed in a commercial processing operation but modified in duration to compensate for the greater exposure of the membrane to the cleaning agents (caustic and acid) in the filter assembly. Prior to the washing steps the membrane was rinsed by circulating water at an initial temperature of 65° C. through the filter assembly for a period of time of three minutes before draining the system.

The membrane was subjected to a first wash by circulating a 2% (w/v) sodium hydroxide solution (“caustic wash”) through the filter assembly for a period of time of five minutes before draining and flushing the system by circulating water at an initial temperature of 65° C. through the filter assembly system for a period of time of five minutes. The membrane was subjected to a second wash by circulating a 28 (w/w) nitric acid solution (“acid wash”) through the filter assembly system for a period of time of ten minutes before draining and flushing the system of circulating water at an initial temperature of 65° C. for a period of time of ten minutes. The membrane was subjected to a third wash (a “caustic wash”) before flushing the system by circulating water at an initial temperature of 65° C. for a period of time of five minutes before circulating chilled water for a period of time of five minutes to cool the system. All rinsing and washing steps were performed with no pressure recorded on the pressure gauge of the filter assembly.

### Hydrophilicitized Microporous Sheets of Polyolefin

### Preparation of poly(4-ethenylbenzenesulfonic Acid)

### EXAMPLE 1

A quantity of 50 g of the monomer 4-ethenylbenzenesulfonic acid as its sodium salt (SSS) was dissolved in a volume of 100 mL of distilled water to provide a solution. A quantity of 0.5 g of the initiator sodium persulfate (SPS) was then dissolved in the solution and the initiator-monomer mixture heated with stirring at a temperature of 80 to 90° C. for a time of about 20 minutes. A viscous solution was obtained having a total volume of about 125 mL. The viscous solution was diluted with the same volume of distilled water to provide 250 mL of a working solution of poly(4-ethenylbenzenesulfonic acid).

The polymer could be precipitated from this working solution by the addition of an excess volume of acetone, followed by collection of the precipitate by filtration through a Buchner funnel and then washing with acetone to provide a light white solid that could be readily ground to a powder using a pestle and mortar.

### EXAMPLE 2

A quantity of 5 g of the monomer 4-ethenylbenzenesulfonic acid as its sodium salt (SSS) was dissolved in a volume of 20 mL of dimethylsulfoxide (DMSO) to provide a solution.

A quantity of 0.05 g of the initiator ammonium persulfate (APS) was then dissolved in the solution and the initiator-monomer mixture heated with stirring at a temperature of 80 to 90° C. for a time of about 20 minutes. The poly(4-ethenylbenzenesulfonic acid) was precipitated from the cooled solution by addition of an excess volume of acetone, collected by filtration through a Buchner funnel and washed with acetone to provide the same light white solid that could be readily ground to a powder obtainable in Example 1.

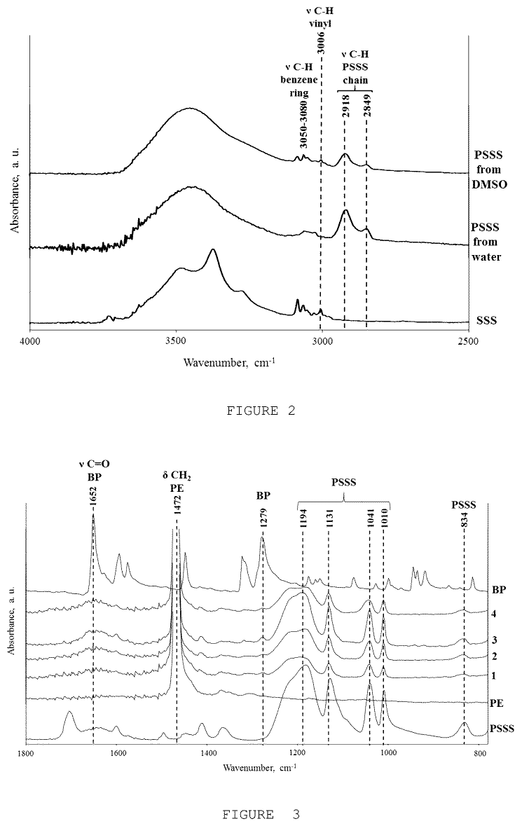

The Fourier transform infrared (FTIR) spectra of the powder obtained by the methods of preparation described in Example 1 (pSSS from water) and Example 2 (pSSS from DMSO) are compared with that of the FTIR spectrum of the monomer 4-ethenylbenzenesulfonic acid (SSS) in FIG. 2. A comparison of the spectra was consistent with the polymerisation of the monomer in both methods of preparation. The polymer prepared by the method described in Example 1, i.e. the working solution, was used as the hydrophilicitizing agent in the preparation of hydrophilicitized sheets of microporous poly(ethylene) according to the following examples.

### Preparation of Hydrophilicitized Microporous Sheets of Poly(Ethylene) Using poly(4-ethenylbenzenesulfonic Acid) (pSSS)

### EXAMPLE 3

A volume of 6 mL of the working solution obtained according to Example 1 was mixed with a volume of 5 mL of distilled water in a vial to provide a volume of initial solution containing 1.2 g of poly(4-ethenylbenzenesulfonic acid) (pSSS). A volume of 10 mL acetone was added to the volume of initial solution and allowed to become transparent before adding and dissolving in the solution a quantity of 0.2 g of the photoinitiator benzophenone (BP) to provide a hydrophilicitizing mixture. The surface of a microporous sheet of poly(ethylene) (TARGRAY™ wet process polyethylene separators, item no. SW320H (Targray, Kirkland QC, Canada)) dimensioned (13.5 cm×18.5 cm) to fit the filter assembly (Sterlitech Corp.) was contacted with the hydrophilicitizing mixture and irradiated with ultraviolet (UV) light (250 nm) for a period of time of 2 minutes. The irradiated contacted sheets were then washed with cold tap water before being placed in a water bath maintained at a temperature of 45 to 50° C. for a time of about 5 minutes. The washed sheets were then air dried before testing or use in the preparation of a composite membrane.

### EXAMPLE 4

The method of preparation described in Example 3 was repeated with the volume of initial solution containing 1.7 g of poly(4-ethenylbenzenesulfonic acid). This quantity of the polymer was close to the maximum that could be dissolved in the solvent system used.

### EXAMPLE 5

A one step method of preparation including the monomer 4-ethenylbenzenesulfonic acid was evaluated.

A volume of 3 mL of the working solution obtained according to Example 1 was mixed with a volume of 8 mL of distilled water and a quantity of 0.6 g of the monomer 4-ethenylbenzenesulfonic acid in a vial to provide a volume of initial solution containing 0.6 g of poly(4-ethenylbenzenesulfonic acid). A volume of 10 mL acetone was added to the volume of this initial solution and allowed to become transparent before adding a quantity of 0.4 g of the photoinitiator benzophenone to provide a hydrophilicitizing mixture.

The surface of a microporous sheet of poly(ethylene) (TARGRAY™ wet process polyethylene separators, item no. SW320H (Targray, Kirkland QC, Canada)) dimensioned (13.5 cm×18.5 cm) to fit the filter assembly (Sterlitech Corp.) was contacted with the hydrophilicitizing mixture and irradiated with UV light (250 nm) for a period of time of 2 minutes before being washed with cold tap water and placed in a water bath maintained at a temperature of 45 to 50° C. for about 5 minutes and then air dried.

### EXAMPLE 6

A two-step method of preparation using only the monomer 4-ethenylbenzenesulfonic acid in the first of the two steps was evaluated.

In the first step a volume of 10 mL of distilled water followed by a volume of 10 mL of acetone was added to a foil wrapped vial containing a quantity of 2.4 g of the monomer and a quantity of 0.4 g of the photoinitiator benzophenone and the mixture shaken until all solids had dissolved. The surface of a microporous sheet of poly(ethylene) (TARGRAY™ wet process polyethylene separators, item no. SW320H (Targray, Kirkland QC, Canada)) dimensioned (13.5 cm×18.5 cm) to fit the filter assembly of a test rig (Sterlitech Corp.) was contacted with the mixture and irradiated with ultraviolet (UV) light (250 nm) before washing with cold tap water and placing in a water bath maintained at a temperature of 45 to 50° C. for a time of 5 minutes before being air dried.

In the second step a volume of 6 mL of the working solution obtained according to Example 1 was mixed with a volume of 5 mL of distilled water in a vial to provide a volume of initial solution containing 1.2 g of poly(4-ethenylbenzenesulfonic acid). A volume of 10 mL acetone was added to the volume of initial solution and allowed to become transparent before adding and dissolving in the solution a quantity of 0.2 of the photoinitiator benzophenone to provide a hydrophilicitizing mixture. The surface of the air dried sheet obtained according to the first step was contacted with the hydrophilicitizing mixture and irradiated with UV light (250 nm) for a period of time of 2 minutes before washing with cold tap water and placing in a water bath maintained at a temperature of 45 to 50° C. for a period of time of about 5 minutes and then air dried.

### Observations

Grafting of the preformed poly(4-ethenylbenzenesulfonic acid) onto the microporous sheet of poly(ethylene) according to the methods of preparation described in Example 3, Example 4, Example 5 and Example 6 was confirmed by washing in acetone (solvent for the photoinitiator benzophenone) and water (solvent for poly(4-ethenylbenzenesulfonic acid)). Four washing protocols (1, 2, 3 and 4) were adopted and the FTIR spectra recorded for samples of hydrophilicitized sheets of microporous poly(ethylene) prepared according to the method described in Example 3 following application of these washing protocols are presented in FIG. 3.

### Preparation of Hydrophilicitized Microporous Sheets of Poly(Ethylene) Using Poloxamer (High Hydrophilicity)

### EXAMPLE 7

A volume of 10 mL of a solution in water of 10% (w/v) triblock copolymer (PLURONIC™ P-123; lot #MKCC2305, Sigma-Aldrich) was mixed with an equal volume of deionised water. A quantity of 0.2 g of the photoinitiator benzophenone (diphenylmethanone; Ph₂O) was dissolved in a separate volume of 10 mL of ethanol before being added to the diluted solution of the triblock copolymer. This working solution was stored in the dark until use.

Samples (13.5×18.5 cm) were cut from a microporous sheet of poly(ethylene) (TARGRAY™ wet process polyethylene separators, item no. SW320H (Targray, Kirkland QC, Canada)) and each sample coated with a volume of the working solution using the rollers from a developmental continuous production line. The coated samples were then irradiated with ultraviolet (UV) light (250 nm) for a period of time of two minutes before rinsing with water and air-drying at room temperature.

The three replicate samples prepared according to this method were designated 040918Wiv, 040918Wv and 040918Vi. A small piece of the sample designated 040918Wiv was excised from the edge of the sample and submitted to scanning electronic microscopy (SEM).

Each of the samples was readily wetted with water.

### Composite Membranes

### Preparation of Composite Membrane Using Microporous Sheet of Poly(Ethylene) Grafted With poly(4-ethenyl Benzene Sulfonic Acid (Low Hydrophilicity)

### EXAMPLE 8

A series of preliminary experiments were performed to evaluate methods of preparing a film of cross-linked poly(ethenol) (xPVA) on a surface. A solution of the radical initiator sodium persulfate (SPS) was prepared by adding a quantity of 0.2 g of SPS to a volume consisting of 10 mL deionised water and 10 mL acetone. The solution of radical initiator was applied onto the surface of each of three glass plates (Plate 1, Plate 2 and Plate 3). Plate 2 and Plate 3 were transferred to an oven and dried at a temperature of 60° C. until all solvent had evaporated to leave a thin layer of the initiator deposited on the surface. Solutions of poly(ethenol) (PVA) were prepared at a concentration of 1% (w/v) in either dimethyl sulfoxide (DMSO) or deionised water. The solution of poly(ethenol) (PVA) in DMSO was sprayed onto the wet surface of Plate 1 and the plate then transferred to an oven and dried at a temperature of 60° C. The solution of poly(ethenol) (PVA) in DMSO was also sprayed onto the dry surface of Plate 2 and the plate then transferred to an oven and dried at a temperature of 60° C. The solution of poly(ethenol) in deionised water was sprayed onto the dry surface of Plate 3 and the plate then transferred to an oven and dried at a temperature of 60° C. The desired film of cross-linked poly(ethenol) was not formed on Plate 1. The failure attributed to the presence of acetone causing the polymer to crash out of solution. The film formed on Plate 2 was too frangible to be useful as a rejection layer of an asymmetric composite membrane. A clear, peelable film formed on the surface of Plate 3. The film was not brittle and this method of preparation was adopted for use in the preparation of the asymmetric composite membrane.

EXAMPLE 9

A series of preliminary experiments were performed to evaluate methods of preparing a film of partially cross-linked poly(ethenol) (xPVA) and thereby control the properties of the rejection layer of the composite membrane. Volumes of 10 mL of a 18 (w/v) solution of poly(ethenol) (PVA) in deionised water containing a quantity of 0.1 g of SPS were dispensed into each four vials (Vial 1, Vial 2, Vial 3 and Vial 4). The solution in each vial was heated to a temperature of 75° C. and maintained at this temperature with stirring until the following observations were made (and the vials then cooled):
A yellow solid crashed out of solution (Vial 1; 3 to 4 minutes)
A cloudy white solution with some precipitation formed (Vial 2, around 3 minutes)
A cloudy white solution formed (Vial 3; 1.5 to 2 minutes).
A cloudy solution started to form (Vial 4; 10 to 20 seconds)

The observations are also presented in FIG. 3. The method of preparing partially cross-linked poly(ethenol) according to that formed in Vial 3 was adapted for use in the preparation of the membrane.

### EXAMPLE 10

A volume of 20 mL of the solution of the radical initiator sodium persulfate (SPS) was prepared according to Example 8. A volume of the solution of partially cross-linked poly(ethenol) (xPVA) was prepared according to Example 9 (Vial 3).

The solution of the radical initiator was applied to one surface of a hydrophilicitized microporous sheet of poly(ethylene) prepared according to Example 3. The sheet was then placed on a glass plate and transferred to an oven and dried at a temperature of 60° C. The solution of partially cross-linked poly(ethenol) was applied to the same surface of the dried sheet and the sheet then returned to the oven and dried at 60° C. The dried membrane was then washed with cool water and air dried before evaluation for flux, total solids and salts rejection with different feed streams (water and milk).

### EXAMPLE 11

To facilitate use in the continuous production of membranes on a developmental continuous production line a more viscous solution of partially cross-linked poly(ethenol) (xPVA) was required. Solutions having a final concentration of 5, 8 and 10% (w/v) were therefore prepared and evaluated.

A volume of 11.5 mL of a solution in distilled water of 0.1 g sodium persulfate (SPS) was mixed with a volume of 8.5 mL of a solution in water of 12% (w/v) poly(ethenol) to provide a total volume of 20 mL at a final concentration of 5% (w/v).

A volume of 6.5 mL of a solution in distilled water of 0.2 g sodium persulfate (SPS) was mixed with a volume of 13.5 mL of a solution in water of 12% (w/v) poly(ethenol) to provide a total volume of 20 mL at a final concentration of 8% (w/v).

A volume of 3.5 mL of a solution in distilled water of 0.2 g sodium persulfate (SPS) was mixed with a volume of 16.5 mL of a solution in water of 12% (w/v) poly(ethenol) to provide a total volume of 20 ml at a final concentration of 10% (w/v).

A portion of each of the volumes at a final concentration of 5, 8 and 10% (w/v) poly(ethenol) (PVA) was transferred to a vial and each stirred with heating to 75° C. until the solution turned a pale yellow (cf. Vial 3 of Example 9). These vials containing partially cross-linked poly(ethenol) (xPVA) were then cooled to room temperature.

The volume containing 10% (w/v) partially cross-linked poly(ethenol) (xPVA) was applied to one surface of a hydrophilicitized microporous sheet of poly(ethylene) prepared according to Example 3 using the rollers of the developmental continuous production line before being placed on a glass plate and transferred to an oven and dried at a temperature of 60° C. The composite membrane was then washed with cool water and air dried before evaluation for flux and protein rejection with different feed streams (water and milk) (Table 4).

### Preparation of Composite Membrane Using Microporous Sheet of Poly(Ethylene) Grafted With a Poloxamer (High Hydrophilicity)

### EXAMPLE 12

A volume of a solution in water of 18 (w/w) of the radical initiator sodium persulfate (SPS) and 8% (w/w) partially cross-linked poly(ethenol) (xPVA) prepared according to Example 11 was applied to one surface of a hydrophilicitized microporous sheet of poly(ethylene) prepared according to Example 7. The sheet was then irradiated at a wavelength of 250 nm for a period of time of two minutes before being placed on a glass plate and transferred to an oven and dried at a temperature of 60° C.

### EXAMPLE 13

A volume of a solution in water of 18 (w/w) of the radical initiator sodium persulfate (SPS) and 5% (w/w) poly(ethenol) (PVA) prepared according to Example 11 was applied directly, i.e. without crosslinking, to one surface of a hydrophilicitized microporous sheet of poly(ethylene) prepared according to Example 7. The sheet was then irradiated at a wavelength of 250 nm for a period of time of two minutes before being placed on a glass plate and transferred to an oven and dried at a temperature of 60° C. The composite membrane was then washed with cool water and air dried before evaluation for flux and protein rejection with different feed streams (water and milk) (Table 4).

### EXAMPLE 14

A volume of a solution in water of 18 (w/w) of the radical initiator sodium persulfate (SPS) and 8% (w/w) poly(ethenol) (PVA) prepared according to Example 11 was applied directly, i.e. without crosslinking, to one surface of a hydrophilicitized microporous sheet of poly(ethylene) prepared according to Example 7. The sheet was then irradiated at a wavelength of 250 nm for a period of time of two minutes before being placed on a glass plate and transferred to an oven and dried at a temperature of 60° C. The composite membrane was then washed with cool water and air dried before evaluation for flux and protein rejection with different feed streams (water and milk) (Table 4).

### Evaluation of Samples of Composite Membrane

Replicate samples (240818Si, 240818Sii, 240818Siii, 030918Si, 030918Sii, 030918Siii) of membrane prepared according to Example 10 were evaluated. The results of this evaluation are summarised in Table 1. Following an initial wetting with 208 (v/v) isopropanol in water, fluxes in the range 7.8 to 10.9 litres per square meter per hour (LMH) were obtainable for a feed stream of water at a pressure of 10 bar. Similar, if not slightly greater fluxes were obtained for a solution of salts with salt rejection in excess of 20%. For a feed stream of whole milk, fluxes were reduced but provided in excess of 50% total solids rejection and well in excess of greater than 99% protein rejection.

TABLE 1
Evaluation of samples of asymmetric composite membrane prepared according
to Example 10. The sample (240818Siii) demonstrating the highest salt rejection
was also evaluated along with two other samples (030918Sii and 030918Siii)
for total solids and protein rejection with milk as a feed stream.

| | | | Salt | | Total solids | Protein |
|---|---|---|---|---|---|---|
| | Initial flux | Salt flux | rejection | Milk flux | rejection | rejection |
| Sample | (LMH) | (LMH) | (%) | (LMH) | (%) | (%) |
| 240818Si | 10.9 at 10 bar | 11.7 at 10 bar | 20.3 | — | — | |
| 240818Sii | 7.8 at 10 bar | 10.7 at 10 bar | 21.3 | — | — | |
| 240818Siii | 8.9 at 10 bar | 10.3 at 10 bar | 28.4 | 4.5 at 10 bar | 63.0 | 99.95 |
| 030918Si | 2.1 at 5 bar | — | — | 1.3 at 10 bar | — | 99.83 |
| 030918Sii | — | — | — | 0.7 at 5 bar | 62.4 | 99.99 |
| 030918Siii | — | — | — | 0.6 at 5 bar | 55.7 | 100.00 |

TABLE 2
Flux, total solids and protein rejection of a sample of an asymmetric
composite membrane (030918Sii) prepared according to Example
10 during repeated clean-in-place (CIP) protocols.

| Number | Milk flux | Total solids | Protein |
|---|---|---|---|
| of CIPs | (LMH) | rejection (%) | rejection (%) |
| 0 | 0.7 | 62.4 | 99.99 |
| 1 | 2.3 | 55.9 | 99.94 |
| 2 | 2.0 | — | 99.94 |
| 3 | 4.7 | 50.7 | 99.93 |
| 4 | 5.0 | 46.3 | 99.88 |
| 5 | 5.7 | 42.0 | 99.84 |
| 10 | 5.7 | 49.0 | 99.87 |

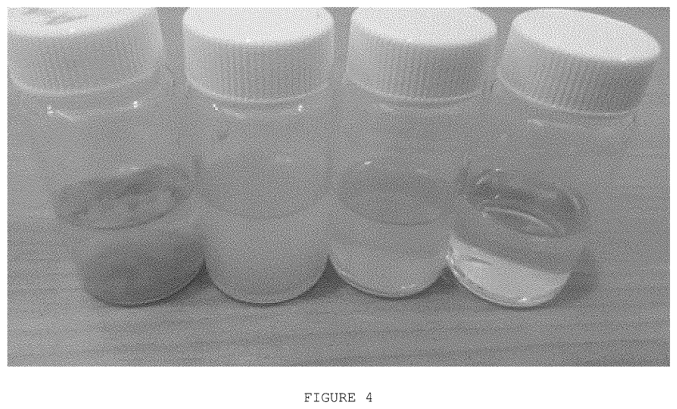

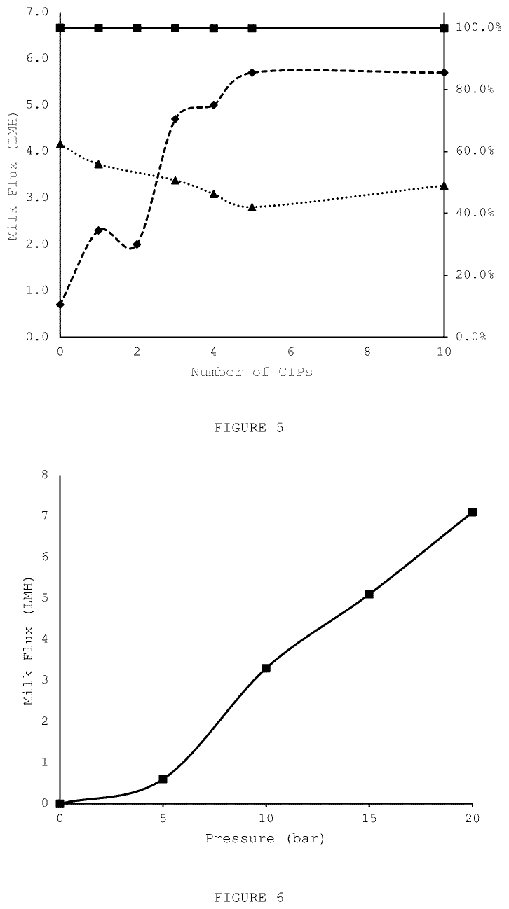

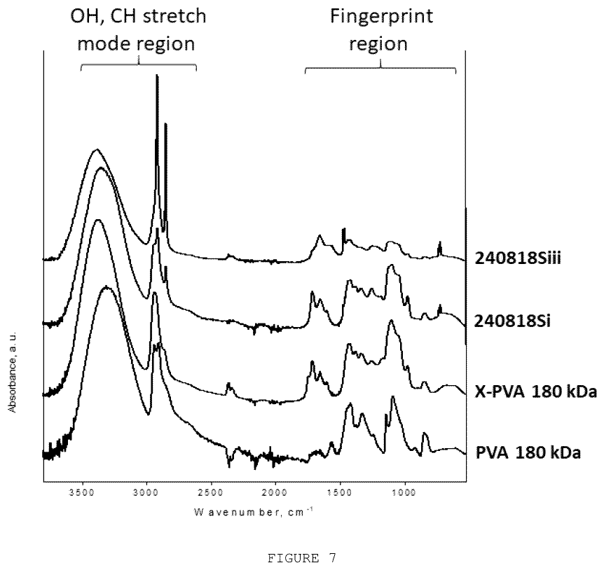

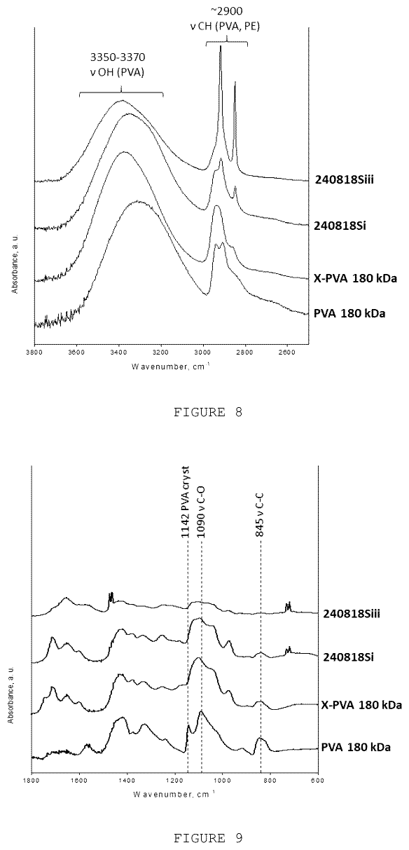

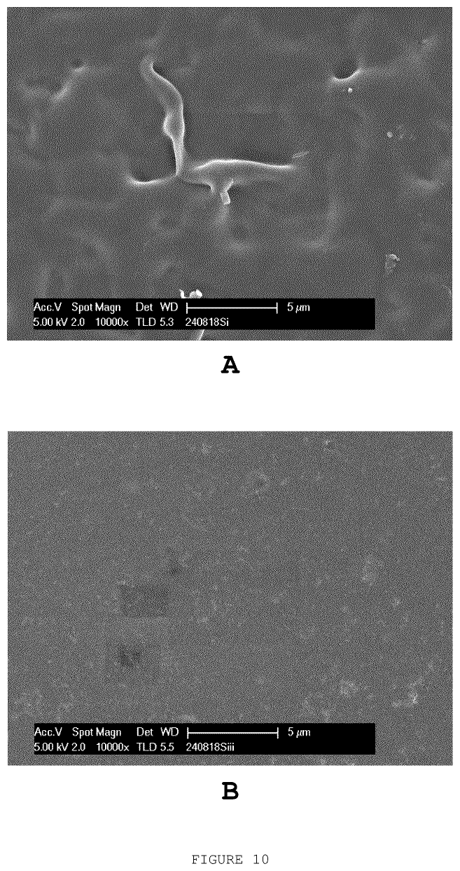

One of the samples (030918Sii) was further evaluated for its tolerance to clean-in-place (CIP) protocols. One of the samples (030918Siii) was also further evaluated in a pressure series test to see how the flux and protein rejection were affected. The results of these further evaluations are summarised in Tables 2 and 3 and FIGS. 4 and 5.

TABLE 3
Pressure series testing (0 to 20 bar) of a sample (030918Siii)
of an asymmetric composite membrane prepared according
to Example 10. Flux and protein rejection with milk
as the feed stream were measured.

| | Milk flux | Protein |
|---|---|---|
| Pressure | (LMH) | rejection (%) |
| 0 | — | 99.99 |
| 5 | 0.6 | 99.94 |
| 10 | 3.3 | 99.94 |
| 15 | 5.1 | 99.93 |
| 20 | 7.1 | 99.88 |

Samples of composite membrane prepared according to Example 11, Example 13 and Example 14 were evaluated. A protein rejection above 99.9% was observed for all samples. Increases in the concentration of poly(ethenol) (PVA) used to prepare the rejection layer were observed to reduce the flux for both water and milk as the feed stream. This is attributed to the increasing concentrations increasing the viscosity of the solution applied to the hydrophilicitized microporous sheet of polyolefin and reduced ease of application on the developmental continuous production line. For example, the viscosity of solutions prepared at a concentration of 10% (w/v) or more of poly(ethenol) is too high, limiting the facility with which a thin, consistent coating can be achieved. By contrast, the viscosity of solutions prepared at a concentration of 5% (w/v) or less of poly(ethenol) is too low, again limiting the facility with which a thin, consistent coating can be achieved. A concentration around 8% (w/v) appears to be optimal as this scale of continuous production.

TABLE 4
Evaluation of samples of membrane prepared according to Example
11, Example 13 and Example 14. (*indicates sample of membrane
evaluated after clean-in-place protocol and drying).

| | Average water | Average milk | |
|---|---|---|---|
| | flux at | flux at | Protein |
| Membrane | 5 bar (LMH) | 5 bar (LMH) | rejection |
| 8% xPVA adhered to | 11.7 | 7.8 | 99.97% |
| poloxamer-μPE | | | |
| Example 14*) | | | |
| 10% xPVA adhered | 3.8 | 1.8 | 99.96% |
| to pSSS-μPE | | | |
| (Example 11) | | | |
| 5% xPVA adhered to | 32.2 | 11.6 | 99.92% |
| poloxamer-μPE | | | |
| Example 13) | | | |
| 8% xPVA adhered to | 7.0 | 3.8 | 99.91% |
| poloxamer-μPE | | | |
| (Example 14) | | | |
| poloxamer-μPE | 826 | 20.6 | 99.56% |
| (Example 7) | | | |

EXAMPLE A—PREPARATION OF FILTRATION MEMBRANE (LABORATORY METHOD, POLOXAMER ONLY)

A volume of 5 mL of a solution in water of 10% (w/v) triblock copolymer (PLURONIC™ P-123; lot #MKCC2305, Sigma-Aldrich) was mixed with an equal volume of deionised water. A quantity of 0.1 g of the photoinitiator benzophenone (diphenylmethanone; Ph₂O) was dissolved in a separate volume of 5 mL of ethanol before being added to the diluted solution of the triblock copolymer. The working solution was stored in the dark until use.

Samples (13.5×18.5 cm) were cut from a sheet of microporous poly(ethylene) (TARGRAY™ wet process polyethylene separators, item no. SW320H (Targray, Kirkland QC, Canada)) and each sample coated with a volume of 5 mL of the working solution. The coated samples were then irradiated with ultraviolet (UV) light in the range 250 to 360 nm for a period of time of two minutes before rinsing with water and air-drying on top of a warm oven.

The four replicate samples prepared according to this method were designated 040918Wiv, 040918Wv, 040918Wvi and 151018Wi. A small piece of the sample designated 040918Wiv was excised from the edge of the sample and submitted to scanning electronic microscopy (SEM).

Each of the samples was readily wetted with water, being observed to become uniformly translucent when contacted with this solvent.

### Durability, Flux and Protein Rejection

A filtration membrane assembly (Sterlitech) as illustrated in FIG. 1 was used to determine flux (LMH) for each of the samples designated 040918Wiv, 040918Wv and 040918Wvi. Samples were individually mounted in the filtration membrane assembly and the flux determined at 0 and 5 bar. The time to collect a predetermined volume of permeate at the specified pressure and temperature was recorded and the flux (J) was calculated according to the following equation:

$$J = \frac{V}{t \times A}$$

where V was the volume of permeate (L), t was the time (h) for the collection of V and A was area of the sample (m²) exposed to the feed stream (water or skim milk). The results are summarised in Table 1.

TABLE 1
Fluxes (LMH) determined at 0 and 5 bar with water as
the feed stream at the temperatures (° C.) specified.

| | Temperature | Flux | |
|---|---|---|---|
| Sample | 0 bar/5 bar | 0 bar | 5 bar |
| 040918Wiv | 9/9 | 10 | 367 |
| 040918Wv | 15/11 | 33 | 476 |
| 040918Wvi | 10/9 | 32 | 428 |

To assess durability fluxes were also determined after repeated clean-in-place (CIP) protocols. The CIP protocol was based on that employed in a commercial processing operation for reverse osmosis (RO) membranes (Anon (2014)) and is summarised in Table 2.

For each sample, a number of CIP protocols were repeated alternating with the use of water or skim milk as the feed stream. The fluxes and percentage protein rejection (with skim milk as the feed stream) determined for the samples designated 040918Wv and 040918Wvi are provided in Table 3. Total protein concentrations in permeate were calculated on the basis of HPLC analysis with UV absorbance monitoring.

TABLE 2
Clean-in-place (CIP) protocol adapted from Anon (2014). The ‘alkali’
was 2% (w/v) sodium hydroxide (NaOH). The ‘acid’ was 1.9% (w/v)
nitric acid (H₂NO₃) and 0.6 (w/v) phosphoric acid (H₃PO₄).

| Step | Feed stream | Time (min) | Temperature (° C.) |
|---|---|---|---|
| 1 | water | 5 | Ambient |
| 2 | water | 5 | 35 |
| 3 | alkali | 5 | 35 |
| 4 | water | 5 | 35 |
| 5 | acid | 10 | 35 |
| 6 | water | 5 | Ambient |
| 7 | hypochlorite | 5 | 35 |
| 8 | water | 5 | Ambient |

TABLE 3
Fluxes (LMH) and protein rejection determined at 0 and
5 bar with water or skim milk as the feed stream at the
temperatures (° C.) specified. Determinations were made for
each of the samples following repeated clean-in-place (CIP) protocols.

| | Feed | CIP | Temperature (° C.) | Flux (LMH) | | Protein |
|---|---|---|---|---|---|---|
| Sample | stream | protocols | 0 bar/5 bar | 0 bar | 5 bar | rejection (%) |
| 040918Wiv | water | 0 | 9/9 | 10 | 367 | |
| 040918Wv | water | 0 | 15/11 | 33 | 476 | |
| 040918Wv | water | 1 | 10/10 | 6 | 139 | |
| 040918Wv | water | 2 | —/12 | — | 195 | |
| 040918Wv | water | 3 | —/11 | — | 171 | |
| 040918Wv | water | 6 | —/10 | — | 476 | |
| 040918Wv | water | 10 | 11/10 | 46 | 494 | |
| 040918Wv | milk | 3 | —/11 | — | 21 | |
| 040918Wv | water | 6 | —/10 | — | 476 | |
| 040918Wv | water | 10 | 11/10 | 46 | 494 | |
| 040918Wv | milk | 10 | 11/12 | 4 | 21 | 99.4 |
| 040918Wvi | water | 0 | 10/9 | 32 | 428 | |
| 040918Wvi | water | 1 | 19/10 | 43 | 642 | |
| 040918Wvi | water | 2 | 13/12 | 40 | 714 | |
| 040918Wvi | water | 3 | 10/10 | 38 | 644 | |
| 040918Wvi | milk | 3 | 9/11 | 3 | 24 | |
| 040918Wvi | water | 4 | —/9 | — | 56 (dry) | |
| 040918Wvi | milk | 4 | —/10 | — | 9 | 99.71 |
| 040918Wvi | water | 5 | 10/9 | 38 | 234 | |
| 040918Wvi | water | 7 | 9/9 | 60 | 803 | |
| 040918Wvi | water | 10 | 11/10 | 64 | 188 | |
| 040918Wvi | milk | 10 | —/12 | — | 9 | 99.76 |

The durability of the filtration membranes was further evaluated by contacting the sample designated 151018Wi with 2 (w/v) sodium hydroxide (NaOH) for 7 days. The fluxes and percentage protein rejection (with skim milk as the feed stream) determined for these samples are provided in Table 4.

TABLE 4
Fluxes (LMH) and protein rejection determined at 0 and 5 bar with
water or skim milk as the feed stream at the temperatures (° C.)
specified. Determinations were made for the samples following
exposure to 2% (w/v) sodium hydrozide (NaOH) for 7 days.

| | Feed | Temperature (° C.) | Flux (LMH) | | Protein |
|---|---|---|---|---|---|
| Sample | stream | 0 bar/5 bar | 0 bar | 5 bar | rejection (%) |
| 151016Wi | water | 9/9 | 54 | 257 | |
| 151016Wi | milk | 10/10 | — | 8 | 99.65 |

### Fourier Transform Infrared (FTIR) Spectroscopy

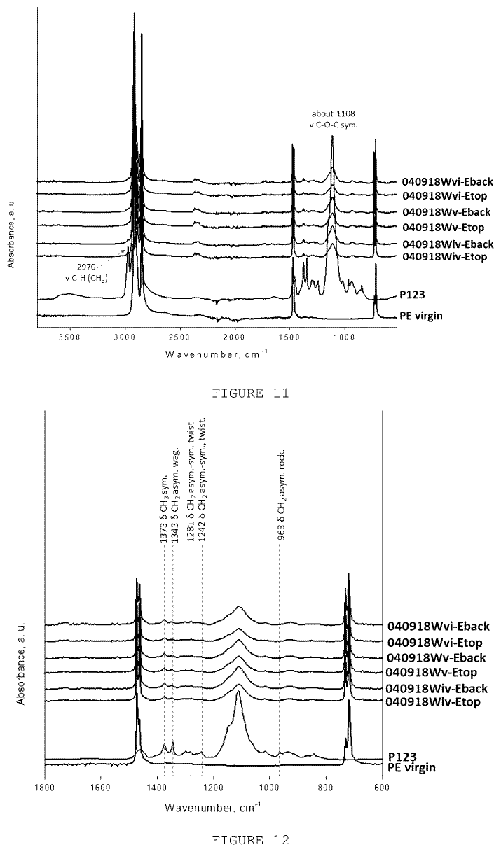

Spectra were recorded for each of the samples designated 040918Wiv, 040918Wv and 040918Wvi using a Thermo Electron Nicolet 8700 FTIR spectrometer equipped with a single bounce ATR and diamond crystal. Thirty-two scans at a resolution of 4 cm⁻¹ were averaged for each sample. A comparison of the spectra (3800 cm⁻¹ to 525 cm⁻¹) recorded for: (i) the untreated microporous poly(ethylene) (TARGRAY™ wet process polyethylene separators, item no. SW320H (Targray, Kirkland QC, Canada)) (‘PE virgin’); (ii) the triblock copolymer (PLURONIC™ P-123; lot #MKCC2305, Sigma-Aldrich) used in the preparation of the samples (‘P123’); and (iii) the top (Etop) and back (Eback) sides of each of the samples designated 040918Wiv, 040918Wv and 040918Wvi is provided in FIG. 11.

Signals corresponding to the symmetrical stretch mode of C—O—C fragments (1108 cm⁻¹) and the C—H stretch mode of CH₃ (2970 cm⁻¹) present in the spectrum of the triblock copolymer (PLURONIC™ P-123) were also present in the spectra recorded for each of the samples. Many signals characteristic of the triblock copolymer (PLURONIC™ P-123) were also observed at low intensity in the ‘fingerprint’ region of the spectra provided in FIG. 12. Signals characteristic of the triblock copolymer (PLURONIC™ P-123) were retained in spectra recorded for regions of the sample designated 040918Wiv following exposure to the feed stream (water) as shown in FIG. 13.

### SEM

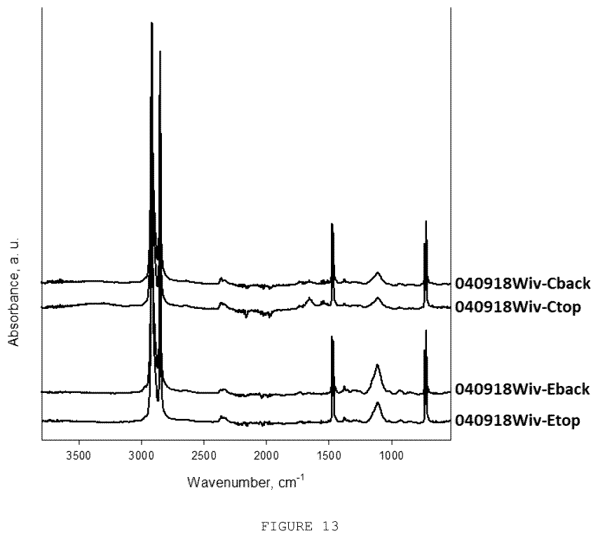

Scanning electron micrographs of the small piece excised from the edge of the sample designated 040918Wiv are provided in FIG. 14 and FIG. 15. The fibres of poly(ethylene) of the microporous sheet appear to be coated.

The observations from FTIR spectroscopy and SEM appeared to demonstrate the grafting of the poloxamer to the polyolefin matrix of the microporous sheet. The conversion of the inherently hydrophobic microporous sheet of polyolefin to a water-wettable permeable membrane is attributed to this grafting.

### EXAMPLE B—PREPARATION OF FILTRATION MEMBRANE (LABORATORY METHOD)

A volume of 10 mL of a solution in water of 10% (w/v) triblock copolymer (PLURONIC™ P-123; lot #MKCC2305, Sigma-Aldrich) was mixed with an equal volume of deionised water. Quantities of 0.2 g of the photoinitiator benzophenone (diphenylmethanone; Ph₂O) and 0 or 0.1 g of the crosslinking agent divinylbenzene (DVB) were dissolved in separate volumes of 10 mL of ethanol (methylated spirits) before being added to a volume of 10 mL of the diluted solution of the triblock copolymer. These working solutions—excluding or including the crosslinking agent DVB—were stored in the dark until use.

Samples (13.5×18.5 cm) were cut from a sheet of microporous poly(ethylene) (TARGRAY™ wet process polyethylene separators, item no. SW320H (Targray, Kirkland QC, Canada)) and each sample coated with a volume of one of the working solutions. The coated samples were then irradiated with ultraviolet (UV) light in the range 250 to 360 nm for a period of time of two minutes before rinsing with water and air-drying in open air.

The three replicate samples prepared according to this method using the working solution excluding DVB were designated 110419Wi, 180419Wi and 180419Wii. The three replicate samples prepared according to this method with the working solution including DVB were designated 230419Wi, 230419Wii and 230419Wiii. Each of the samples was readily wetted with water, being observed to become uniformly translucent when contacted with this solvent.

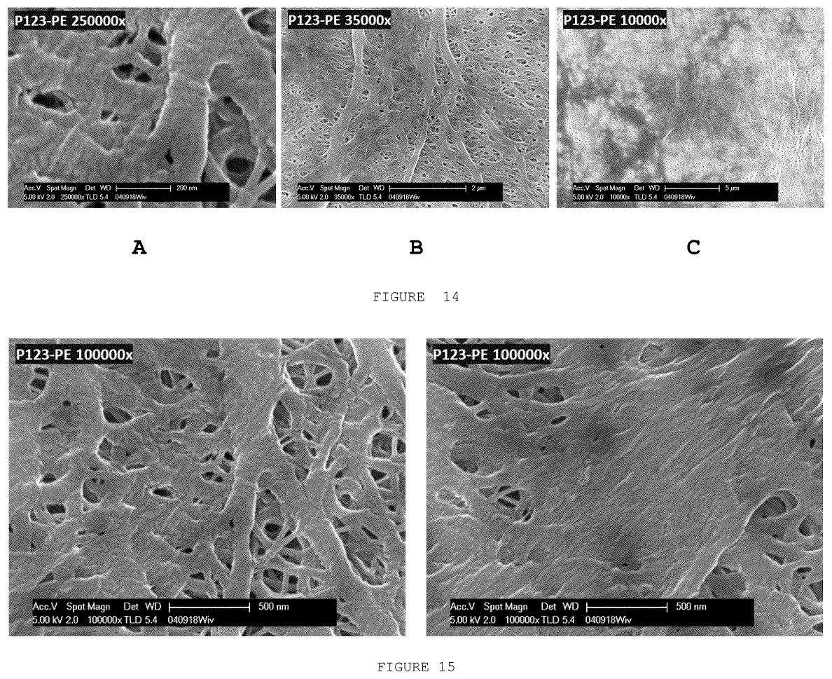

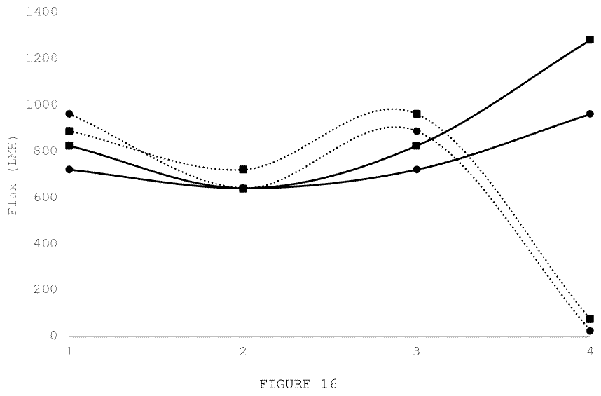

The water flux was determined for each of the samples with deionised water as the feed stream (DI1). The samples were then completely dried before again determining the water flux with deionised water as the feed stream (DI2). Each of the samples were then subjected to a clean-in-place (CIP) protocol before twice more determining the water flux with deionised water as the feed stream (DI3 and DI4) and an intervening drying of the samples. Each of the samples remained readily wettable with water. The results are summarised in Table 5 and Table 6 and compared in FIG. 16.

### EXAMPLE C—PREPARATION OF FILTRATION MEMBRANE (PROTOTYPE METHOD)

A volume of 300 mL of a solution of 10% (w/v) triblock copolymer (PLURONIC™ P-123; lot #MKCC2305, Sigma-Aldrich) in distilled water was dispensed into a reservoir protected from exposure to light. A further volume of 300 mL of distilled water was then added to provide an initial solution of 58 (w/v) triblock copolymer (PLURONIC™ P-123; lot #MKCC2305, Sigma-Aldrich) in the reservoir. A solution of 1.5% (w/v) benzophenone in ethanol (methylated spirits) was prepared separately and a volume of the crosslinking agent divinylbenzene (DVB) added to provide a final concentration of 0.75% (v/v) DVB. A volume of 400 mL of this separately prepared solution was then mixed with the solution of triblock copolymer (PLURONIC™ P-123; lot #MKCC2305, Sigma-Aldrich) in a reservoir to provide the working solution.

TABLE 5
Average fluxes (LMH) determined at room temperature (22 to 24° C.)
at 0 and 5 bar with water as the feed stream (*membrane failure).
No crosslinking aqent included in the ‘working solution’.

| | | Flux | |
|---|---|---|---|
| Sample | DI# | 0 bar | 5 bar |
| 110419Wi | 1 | 61 | 964 |
| | 2 | 32 | 771 |
| | 3 | 38 | 964 |
| | 4 | 95 | 1446* |
| 180419Wi | 1 | 70 | 890 |
| | 2 | 35 | 723 |
| | 3 | 48 | 964 |
| | 4 | — | 76 |
| 180419Wii | 1 | 62 | 964 |
| | 2 | 34 | 643 |
| | 3 | 36 | 890 |
| | 4 | — | 26 |

Referring to FIG. 17 of the accompanying drawings pages, peristaltic pumps (1,2) were used to deliver the working solution from the reservoirs (3,4) to the two hemicylindrical troughs (5,6) of a prototype production line. The reservoirs were periodically replenished with the working solution during the operation of the prototype production line.

The width of a continuous microporous sheet (7) of microporous poly(ethylene) was fed from a dispensing roll of stock into a first impregnation station comprising an idler roller (8) co-axially mounted in the first of the two hemicylindrical troughs (5). The difference between the radii of the roller (8) and trough (5) was sufficient to permit free passage of the sheet (7) around the roller and through the trough, but not so great as to promote evaporation of the working solution in the trough. The surface of the roller (8) over which the sheet (7) passes may be spiral engraved to promote passage of the working solution across the length of the surface.

TABLE 6
Average fluxes (LMH) determined at room temperature (22 to 24° C.)
at 0 and 5 bar with water as the feed stream. Crosslinking
agent (DVB) included in the ‘working solution’.

| | | Flux | |
|---|---|---|---|
| Sample | DI# | 0 bar | 5 bar |
| 230419Wi | 1 | 43 | 680 |
| | 2 | 15 | 321 |
| | 3 | 24 | 609 |
| | 4 | 15 | 399 |
| 230419Wii | 1 | 345 | 826 |
| | 2 | 28 | 642 |
| | 3 | 34 | 826 |
| | 4 | 17 | 1285 |
| 230419Wiii | 1 | 26 | 723 |
| | 2 | 33 | 642 |
| | 3 | 56 | 723 |
| | 4 | 26 | 964 |

The sheet (7) exiting the first impregnation station was then fed vertically into a first irradiating station comprising a slotted chamber (9) containing two opposed arrays (10,11) of ultraviolet light sources. The sheet (7) passed between the opposed arrays (10,11) so that both sides were irradiated. The rate at which the sheet (7) was fed was regulated to provide the required residence time within the slotted chamber (9).

The irradiated sheet (7) was then passed through a second impregnation station (12) and second irradiating station (13) of the same configuration as the first impregnation station and first irradiating station. Following these repeated steps, the irradiated sheet (7) was fed around a plurality of idler rollers (14,15,16) immersed in water in a washing station (17). The water in the washing station (17) was circulated by an external pump (18) and the depth of the water controlled by a combination of level transmitter and solenoid valve (19). The combination of a plurality of idler rollers (14,15,16) and depth of water ensured sufficient residence time before the water washed sheet (7) was fed into the drying station.

The drying station was a forced air dryer comprising two plenum chambers (20,21) having opposed perforated face plates between which the sheet of substrate passed. Hot air blowers (22,23) mounted in the wall of each chamber forced air through the perforated face plates. The dried sheet (7) of substrate was then rewound onto a receiving roll (not shown).

### EXAMPLE D—SPIRAL WOUND FILTER ELEMENTS, HOUSING AND RIG

Spiral-wound filter elements were manufactured using filtration membrane prepared according to the prototype method (EXAMPLE C). The filter elements were wound using type 34 diamond spacers. Two spiral-wound filter elements were mounted in series in each of two housings mounted in an assembly (‘rig’).

### EXAMPLE E—RECOVERY OF CLEANING SOLUTIONS

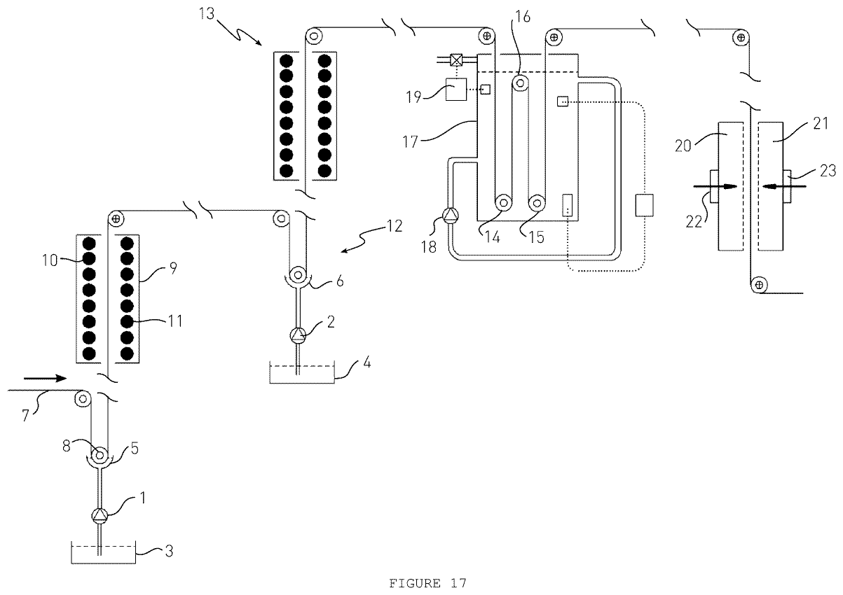

A volume of 900 litres of caustic cleaning solution that had been used to sanitize wine tanks was collected and transferred in two volumes of 300 litres and 600 litres, respectively, to the reservoir of the rig and delivered via a recirculating pump to the inlet ports of the filter housings. The used caustic solution had a translucent appearance attributed to the suspension of particulates (FIG. 15, left). The solution was pumped under constant pressure from the reservoir to the rig to provide flow rates at the filter housing inlets of 110 to 120 litres per minute (FIG. 19). Permeate was collected from each of the filter housing outlets at an initial rate of around 9 litres per minute, declining to a near steady rate of 5.8 litres per minute over the duration of the pump run (FIG. 20). The observed decline in flux was attributed to the concentration of the retentate in the closed system (as opposed to fouling of the membrane or spacer). This attribution is supported by the near steady flow rates observed at the housing inlets.

Over an initial duration of 2.5 hours (including 20 minutes downtime during which the contents of the reservoir were replenished) a volume concentration factor (VCF) of 8.18 was achieved. This equates to the recovery of 88% of the caustic cleaning solution.

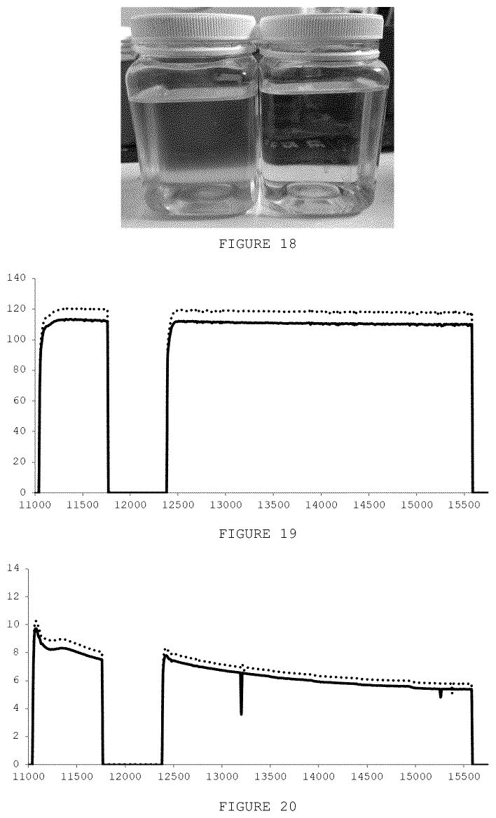

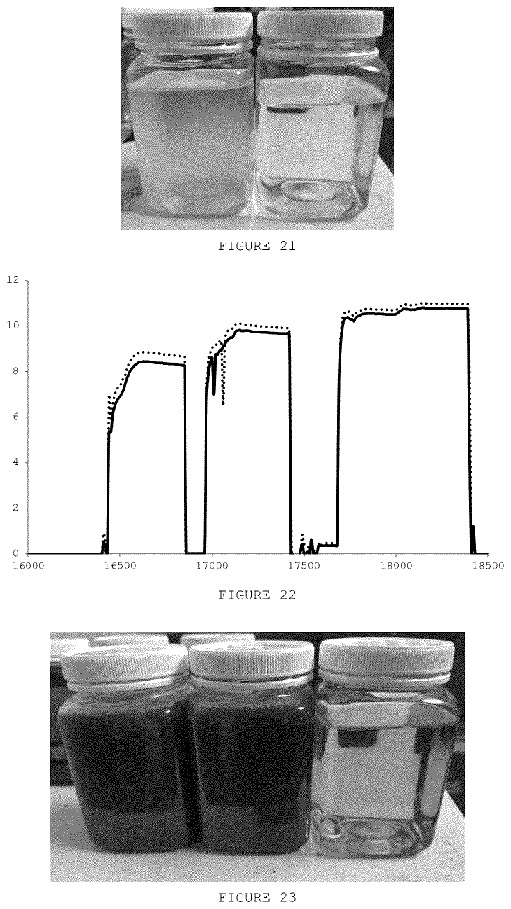

Replenishing the contents of the reservoir with a further volume of 600 litres of caustic cleaning solution that had been used to sanitize wine tanks, but containing less pigments (FIG. 21, left), and repeating the foregoing increased the volume concentration factor to 15. Increases in the permeate flux rates were observed with this second feed stock (FIG. 22) supporting minimal fouling of the membranes and spacers having occurred during the initial run.

Replenishing the contents of the reservoir with a further volume of 500 litres of caustic cleaning solution that had been used to sanitize wine tanks that were heavily contaminated with solids (FIG. 23, left), a final volume concentration factor of 20 was achieved, albeit with a reduced permeate flux of around 3 litres per minute. A volume concentration factor of 20 equates to a recovery of 95% (w/w) of the caustic cleaning solution.

Samples of the cumulative volumes (900 L, 1,500 L and 2,000 L) of recovered caustic cleaning solution were titrated to pH 7 using 0.1 N sulphuric acid (H₂SO₄) and an auto-titrator.

TABLE 7
Recovery of caustic cleaning solution from a series of
cleaning operations. (*Dilution of feed stream during processing.)

| Cumulative volume | pH (initial) | | | Titration volume (mL) | | | Permeate |
|---|---|---|---|---|---|---|---|
| (L) of used | feed | | | feed | | | recovery |
| cleaning solution | stream | retentate | permeate | stream | retentate | permeate | (% (v/v)) |
| 900 | N/A | N/A | N/A | — | 8.13 | 8.28 | 98.2 |
| 1,500 | 11.93 | 11.94 | 11.98 | 3.09 | 3.09 | 3.12 | 99.1 |
| 2,000 | 10.52 | — | 11.96 | 0.67* | — | 3.02 | 97.7 |

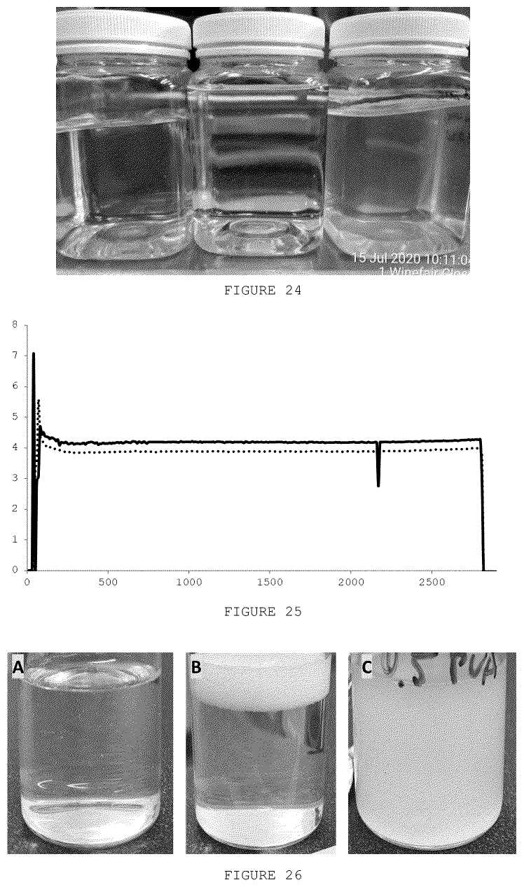

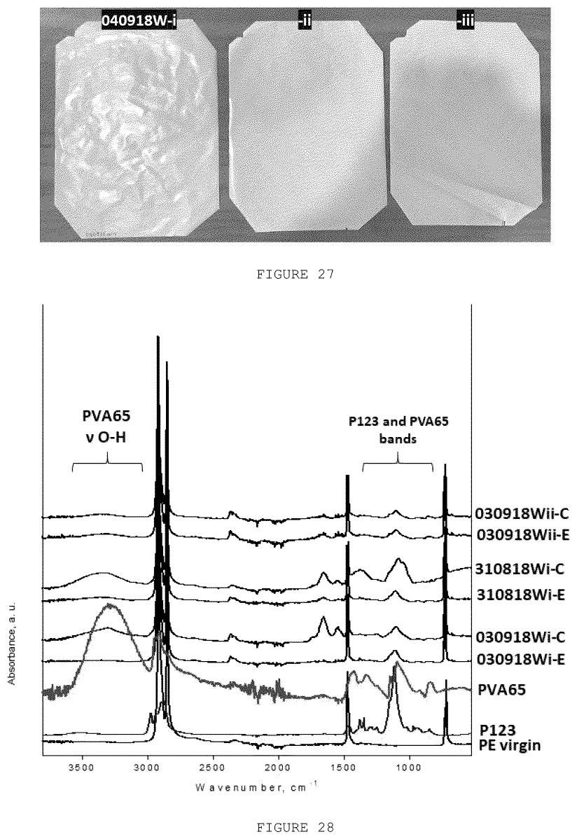

To confirm the tolerance of the membrane to multiple chemistries and its utility in the recovery and reuse of the cleaning solutions typically used in beverage and food processing, a volume of citric acid cleaning solution that had been used in the cleaning of a wine tank was collected (FIG. 24, left). The volume was transferred to the cleaned reservoir and delivered via the pump at a similar flow rate to the filter housing inlets. A permeate flow rate averaging around 4 litres per minute for the duration of the run was obtained (FIG. 25). Greater than 95% (w/w) of the citric acid cleaning solution was recovered.

### EXAMPLE F—REUSE OF CLEANING SOLUTIONS

Recovered cleaning solutions were used to sanitize wine tanks and the efficacy of these procedures evaluated. The cleaning solutions were repeatedly recovered and reused to confirm the commercial viability of the procedures. In addition to the evaluation of the efficacy of the sanitization operations the content of the recovered and reused cleaning solutions was determined by titration as before (Tables 8 and 9).

TABLE 8
Recovery and reuse of caustic cleaning solution.

| Recovery | pH (initial) | | Titration volume (mL) | | % |
|---|---|---|---|---|---|
| (reuse) | feed stream | permeate | feed stream | permeate | recovery |
| First | 12.42 | 12.34 | 14.02 | 14.28 | 102 |
| Second | 12.11 | 12.43 | 4.81 | error | n.d. |
| (first) | | | | | |
| Third | 11.94 | 12.13 | 5.17 | 5.13 | 99.2 |
| (second) | | | | | |
| Fourth | 12.33 | 13.34 | 4.61 | 4.61 | 100 |
| (third | | | | | |
| Fifth | 12.13 | 12.09 | 4.13 | 3.98 | 96.5 |
| (fourth) | | | | | |

TABLE 9
Recovery and reuse of citric acid cleaning solution.

| Recovery | Titration volume (ML) | | | |
|---|---|---|---|---|
| (reuse) | feed stream | retentate | permeate | % recovery |
| First | 5.71 | 5.65 | 5.62 | 98.4 |
| Second | 5.01 | 5.12 | 5.08 | 99.2 |
| (first) | | | | |

### EXAMPLE G—PREPARATION OF FILTRATION MEMBRANE (LABORATORY METHOD, BLEND OF POLYMERS)

### Method 1

A volume of 5 ml of a solution in water of 10% (w/v) triblock copolymer (PLURONIC™ P-123; lot #MKCC2305, Sigma-Aldrich) was mixed with an equal volume of a solution in water of 0.25 g of poly(ethenol) (PVA, 65 kDa). A quantity of 0.1 g of the photoinitiator benzophenone (diphenylmethanone; Ph₂O) was dissolved in a separate volume of 5 mL of ethanol before being added to the solution of the triblock copolymer and poly(ethenol) (PVA, 65 kDa). The solution (‘working solution A’) was stored in the dark until use.

### Method 2

A volume of 5 mL of a solution in water of 10% (w/v) triblock copolymer (PLURONIC™ P-123; lot #MKCC2305, Sigma-Aldrich) was mixed with a volume of 3 mL of a solution in water of 0.15 g of poly(ethenol) (PVA, 65 kDa). A quantity of 0.1 g of the photoinitiator benzophenone (diphenylmethanone; Ph₂O) was dissolved in a separate volume of 5 mL of ethanol before being added to the solution of the triblock copolymer and poly(ethenol) (PVA, 65 kDa). The solution (‘working solution B’) was stored in the dark until use.

### Method 3

A quantity of 0.5 g triblock copolymer (PLURONIC™ P-123; lot #MKCC2305, Sigma-Aldrich) was dissolved in a volume of 10 mL of a solution in water of 0.5 g of poly(ethenol) (PVA, 65 kDa) with the addition of a volume of 5 mL ethanol and at a temperature of 55° C. A quantity of 0.1 g of the photoinitiator benzophenone (diphenylmethanone; Ph₂O) was dissolved in the solution of the triblock copolymer and poly(ethenol) (PVA, 65 kDa) and this turbid, but homogenous solution (‘working solution C’) was stored in the dark until use.

The appearance of each of the working solutions (A, B and C) prepared according to method 1, 2 and 3 is presented in FIG. 26.

### Method 4

Samples (13.5×18.5 cm) were cut from a microporous sheet of poly(ethylene) (TARGRAY™ wet process polyethylene separators, item no. SW320H (Targray, Kirkland QC, Canada)) and each sample coated with a volume of 5 mL of the working solution. The coated samples were then irradiated with ultraviolet (UV) light in the range 250 to 360 nm for a period of time of two minutes before rinsing with water and air-drying on top of a warm oven. Working solution A was used for the preparation of the sample designated 310818wi, working solution B was used for the preparation of the sample designated 030918wii, working solution C was used for the preparation of the sample designated 030918wi.

Each of the samples prepared according to method 4 was highly hydrophilic and readily wetted with water.

### Method 5

A quantity of 0.15 g of poly(ethenol) (PVA, 146 to 186 kDa) (PVA180) was dissolved with heating and stirring in a volume of 10 ml of water. A quantity of 0.5 g of triblock copolymer (PLURONIC™ P-123; lot #MKCC2305, Sigma-Aldrich) was then added to the volume and dissolved. A quantity of 0.1 g of the photoinitiator benzophenone (diphenylmethanone; Ph₂O) was dissolved in a separate volume of 5 mL of ethanol before being added to the volume of the triblock copolymer and poly(ethenol) (PVA, 146 to 186 kDa) (PVA180). The solution (‘working solution D’) was stored in the dark until use.

### Method 6

A sample (13.5×18.5 cm) was cut from a microporous sheet of poly(ethylene) (TARGRAY™ wet process polyethylene separators, item no. SW320H (Targray, Kirkland QC, Canada)) and coated with a volume of 5 mL of working solution D. The coated sample was then irradiated with ultraviolet (UV) light in the range 250 to 360 nm for a period of time of two minutes before rinsing with water and air-drying on top of a warm oven.

Three replicate samples were prepared according to method 5 and designated 041918wi, 041918wii and 041918wiii. The appearance of these samples is provided in FIG. 17.

The flux (LMH) was determined for each of the samples designated 310818wi, 030918wii and 030918wi. A summary of the composition of the working solution used to prepare each sample of membrane and the fluxes determined are presented in Table 10.

TABLE 10
Summary of the composition (g/10 mL) of each
working solution used to prepare each sample of membrane
(310818wi, 030918wii, 030918wi and 040918wi) and the fluxes
(LMH) determined at 0 and 5 bar with water as the feed stream

| | PLURONIC ™ | Benzo- | | | Flux | |
|---|---|---|---|---|---|---|
| Sample | P-123 | phenone | PVA65 | PVA180 | 0 bar | 5 bar |
| 030918wi | 0.5 | 0.1 | 0.15 | — | 26 | 340 |
| 310818wi | 0.5 | 0.1 | 0.25 | — | 22 | 312 |
| 030918wii | 0.5 | 0.1 | 0.5 | — | 11 | 189 |
| 040918wi | 0.5 | 0.1 | — | 0.15 | 10 | 361 |

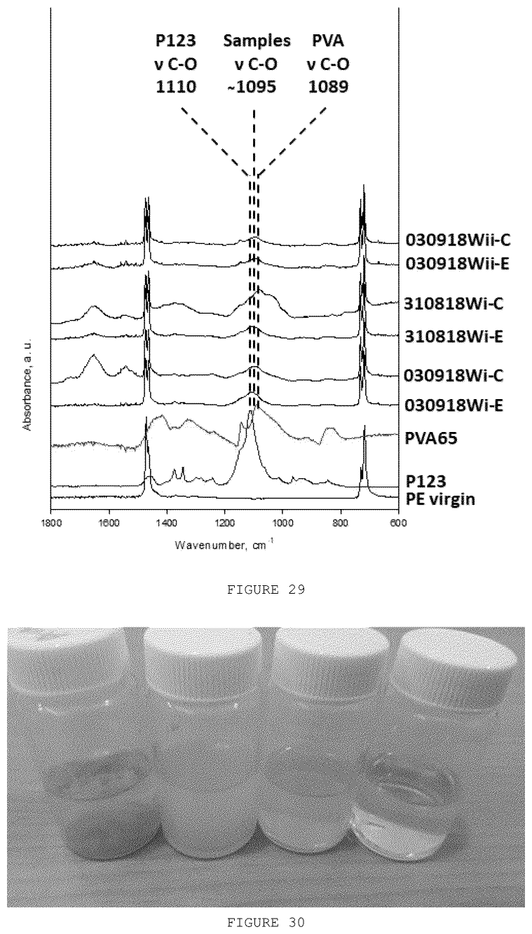

Spectra were recorded for each of the samples designated 310818wi, 030918wii and 030918wi, the untreated microporous poly(ethylene) (TARGRAY™ wet process polyethylene separators, item no. SW320H (Targray, Kirkland QC, Canada)), and the triblock copolymer (PLURONIC™ P-123; lot #MKCC2305, Sigma-Aldrich) and poly(ethenol) (PVA, 65 kDa) used in the preparation of the samples. Spectra were also recorded for the centre (-C) and edge (-E) of each of the samples designated 310818wi, 030918wii and 030918wi. A comparison of the recorded spectra is provided in FIG. 28. A comparison of the same spectra over the ‘fingerprint’ region (1800 cm⁻¹ to 600 cm⁻¹) is provided in FIG. 29. (The edge of each sample was not exposed to the feed stream (water) during the flux testing.)

### EXAMPLE H—PREPARATION OF COMPOSITE MEMBRANES

### Method 1

A series of preliminary experiments were performed to evaluate methods of preparing a film of cross-linked poly(ethenol) (xPVA) on a surface. A solution of the radical initiator sodium persulfate (SPS) was prepared by adding a quantity of 0.2 g of SPS to a volume consisting of 10 mL deionised water and 10 mL acetone. The solution of radical initiator was applied onto the surface of each of three glass plates (Plate 1, Plate 2 and Plate 3). Plate 2 and Plate 3 were transferred to an oven and dried at a temperature of 60° C. until all solvent had evaporated to leave a thin layer of the initiator deposited on the surface. Solutions of poly(ethenol) (PVA) were prepared at a concentration of 1% (w/v) in either dimethyl sulfoxide (DMSO) or deionised water. The solution of poly(ethenol) (PVA) in DMSO was sprayed onto the wet surface of Plate 1 and the plate then transferred to an oven and dried at a temperature of 60° C. The solution of poly(ethenol) (PVA) in DMSO was also sprayed onto the dry surface of Plate 2 and the plate then transferred to an oven and dried at a temperature of 60° C. The solution of poly(ethenol) in deionised water was sprayed onto the dry surface of Plate 3 and the plate then transferred to an oven and dried at a temperature of 60° C. The desired film of cross-linked poly(ethenol) was not formed on Plate 1. The failure attributed to the presence of acetone causing the polymer to crash out of solution. The film formed on Plate 2 was too frangible to be useful as a rejection layer of a composite membrane. A clear, peelable film formed on the surface of Plate 3. The film was not brittle, and this method of preparation was adopted for use in the preparation of the composite membrane.

### Method 2

A series of preliminary experiments were performed to evaluate methods of preparing a film of partially cross-linked poly(ethenol) (xPVA) and thereby control the properties of the rejection layer of the composite membrane. Volumes of 10 ml of a 1% (w/v) solution of poly(ethenol) (PVA) in deionised water containing a quantity of 0.1 g of SPS were dispensed into each four vials (Vial 1, Vial 2, Vial 3 and Vial 4). The solution in each vial was heated to a temperature of 75° C. and maintained at this temperature with stirring until the following observations were made (and the vials then cooled):
A yellow solid crashed out of solution (Vial 1; 3 to 4 minutes)
A cloudy white solution with some precipitation formed (Vial 2, around 3 minutes).
A cloudy white solution formed (Vial 3; 1.5 to 2 minutes)
A cloudy solution started to form (Vial 4; 10 to 20 seconds)

The observations are also presented in FIG. 30. The method of preparing partially cross-linked poly(ethenol) according to that formed in Vial 3 was adapted for use in the preparation of the membrane.

### Method 3

In a proposed alternative method, a volume of 20 mL of the solution of the radical initiator sodium persulfate (SPS) is prepared according to Method 1. A volume of the solution of partially cross-linked poly(ethenol) (xPVA) is prepared according to Method 2 (Vial 3). The solution of the radical initiator is applied to one surface of a hydrophilicitized sheet of microporous poly(ethylene) prepared according to EXAMPLE A. The sheet is then placed on a glass plate and transferred to an oven and dried at a temperature of 60° C. The solution of partially cross-linked poly(ethenol) is applied to the same surface of the dried sheet and the sheet then returned to the oven and dried at 60° C. The dried membrane is then washed with cool water and air dried before evaluation for flux, total solids and salts rejection with different feed streams (water and milk).

### Method 4

A radical initiator containing volume of 8% (w/v) poly(ethenol) (PVA) was prepared by dissolving a quantity of 0.2 g of the radical initiator sodium persulfate (SPS) in a volume of 6.5 mL of distilled water and then adding the solution to a volume of 13.5 mL of 12% (w/v) poly(ethenol) (PVA). The volume of 8% (w/v) poly(ethenol) (PVA) was stirred with heating to 75° C. and monitored until the solution became a pale-yellow colour. The pale-yellow solution was cooled and then applied to a hydrophilicitized sheet of microporous poly(ethylene) prepared according to EXAMPLE A. The sheet was irradiated with ultraviolet (UV) light (250 nm) for 2 minutes before drying on a glass plate in an oven at 60° C.

### Method 5

A radical initiator containing volume of 5% (w/v) poly(ethenol) (PVA) was prepared by dissolving a quantity of 0.2 g of the radical initiator sodium persulfate (SPS) in a volume of 11.5 mL of distilled water and then adding the solution to a volume of 8.5 mL of 12% (w/v) poly(ethenol) (PVA). The volume of 5% (w/v) poly(ethenol) (PVA) was stirred with heating to 75° C. and monitored until the solution became a pale-yellow colour. The pale-yellow solution was cooled and then applied to a hydrophilicitized sheet of microporous poly(ethylene) prepared according to EXAMPLE A. The sheet was irradiated with ultraviolet (UV) light (250 nm) for 2 minutes before drying on a glass plate in an oven at 60° C.

Samples of membrane prepared according to Method 4 and Method 5 were evaluated. The sample prepared according to Method 4 was also evaluated following exposure to a clean-in-place (CIP) protocol. The results of these evaluations are summarised in Table 11.

TABLE 11
Mean flux (LMH) determined for water as the feed stream and
protein rejection (%) and mean flux (LMH) determined for milk as
the feed stream for samples of membrane prepared according to the
specified methods. Both feed streams at a pressure of 5 bar.
(*following exposure to a clean-in-place (CIP) protocol.)

| Method used to | | | |
|---|---|---|---|
| prepare membrane | Water | Milk | Rejection |
| Method 4 | 7.8 | 3.8 | 99.91 |
| Method 4* | 11.7 | 7.8 | 39.97 |
| Method 5 | 32.2 | 11.6 | 99.92 |
| EXAMPLE A | 826 | 20.6 | 99.56 |

For the manufacture of the composite membranes on an industrial scale it is proposed to prepare a radical initiator, e.g. sodium persulfate (SPS), containing solution of 6 to 10% (w/v) poly(ethenol) (PVA) and apply this directly to a hydrophilicitized sheet of microporous polyolefin before irradiating with ultraviolet (UV) light and drying.

Although the invention has been described with reference to embodiments or examples it should be appreciated that variations and modifications may be made to these embodiments or examples without departing from the scope of the invention. Where known equivalents exist to specific elements, features or integers, such equivalents are incorporated as if specifically referred to in this specification. Variations and modifications to the embodiments or examples that include elements, features or integers disclosed in and selected from the referenced publications are within the scope of the invention unless specifically disclaimed. The advantages provided by the invention and discussed in the description may be provided in the alternative or in combination in these different embodiments of the invention.

### INDUSTRIAL APPLICABILITY

Methods of preparing membranes and their use in the recovery of aqueous solutions or water from feed streams are provided. The membranes are advantageously used where the membranes are required to be exposed to chemically aggressive feed streams such as those used in clean-in-place operations of the beverage or food processing industries.

### INCORPORATION BY REFERENCE

Where the claims, description or drawings of this specification are missing in their entirety or part, the corresponding portion of the specification accompanying the most recently filed application from which priority is claimed is to be incorporated by reference so as to complete this specification in accordance with Rules 4.18, 20.5 and 20.6 of the PCT Regulations (as in force from 1 Jul. 2015 or subsequently amended).

For the purposes of 37 C.F.R. 1.57 of the United States Code of Federal Regulations the disclosures of the following publications (as more specifically identified under the heading ‘Referenced Publications’) are incorporated by reference: Briggs et al (2015), Jones et al (2008) and Schmolka (1973).

### REFERENCED PUBLICATIONS

Allmer et al (1988) Surface modification of polymers. I. Vapor-phase photografting with acrylic acid Journal of Polymer Science, Part A: Polymer Chemistry, 26(8), 2099-111.
Allmer et al (1989) Surface modification of polymers. II. Grafting with glycidyl acrylates and the reactions of the grafted surfaces with amines Journal of Polymer Science: Part A: Polymer Chemistry, 27, 1641-1652.
Ang et al (1980) Photosensitized grafting of styrene, 4-vinylpyridine and methyl methacrylate to polypropylene Journal of Polymer Science: Polymer Letters Edition, 18, 471-475.
Anon (2014) DOW FILMTEC™ Membranes—Cleaning procedures for DOW FILMTEC FT30 elements Tech Fact (Form No. 609-23010-0211).
Bai et al (2011) Surface UV photografting of acrylic acid onto LDPE powder and its adhesion Shenyang Huagong Daxue Xuebao 25(2), 121-125.
Bolto et al (2009) Crosslinked poly(vinyl alcohol) membranes Progress in Polymer Science, 34, 969-981.
Briggs et al (2015) Durable asymmetric composite membrane International application no. PCT/NZ2015/050034 [publ. no. WO 2015/147657 A1].
Callis et al (2008) Humidifier membrane International application no. PCT/EP2007/008710 [publ. no. WO 2008/043507 A1].
Carter et al (2018) Controlling external versus internal pore modification of ultrafiltration membranes using surface-initiated AGET-ATRP Journal of Membrane Science, 554, 109-116.
Cheng et al (2017) Method for preparing mesoporous composite film Chinese patent application no. 201611226194 [Publ. no. CN 106731886 A].
Choi (2002) Graft polymerisation, separators, and batteries including the separators U.S. Pat. No. 6,384,100.
Choi (2004) Battery separator U.S. Pat. No. 6,680,144.
Choi (2005) Graft polymerisation, separators, and batteries including the separators U.S. Pat. No. 6,955,865.
Craft et al (2017) Asymmetric composite membrane and a method of preparation thereof International application no. PCT/IB2016/055899 [publ. no. WO 2017/056074 A1].
Edge et al (1993) Surface modification of polyethylene by photochemical grafting with 2-hydroxyethylmethacrylate Journal of Applied Polymer Science, 47, 1075-1082.
El Kholdi et al (2004) Modification of adhesive properties of a polyethylene film by phtografting Journal of Applied Polymer Science 92(5), 2803-2811.
Exley (2016) Asymmetric composite membranes and modified substrates used in their preparation International application no. PCT/IB2015/060001 [Publ. no. WO 2016/103239 A1].
Gao et al (2013) Radiation cross-linked lithium-ion battery separator with high rupture temperature and high tensile strength and manufacture method Chinese patent application no. 2013-10196439 (publ. no. CN 103421208).
Guo et al (2015) Coated microporous materials having filtration and adsorption properties and their use in fluid purification processes International application no. PCT/US2014/061326 [Publ. no. WO 2015/073161 A1].
Jaber and Gjoka (2016) Grafted ultra high molecular weight polyethylene microporous membranes international application no. PCT/US2015/061591 [publ. no. WO 2016/081729 A1].
Jones et al (2008) Compendium of polymer terminology and nomenclature IUPAC Recommendations, RSC Publishing.
Kubota and Hata (1990a) Distribution of methacrylic acid-grafted chains introduced into polyethylene film by photografting Journal of Applied Polymer Science, 41, 689-695.
Kubota and Hata (1990b) Benzil-sensitized photografting of methacrylic acid on low-density polyethylene film Journal of Applied Polymer Science, 40, 1071-1075.
Linder et al (1988) Semipermeable composite membranes, their manufacture and use U.S. Pat. No. 4,753,725.
Liu et al (2014) With multi-scale gradient microstructure surface preparation method of a microporous membrane Chinese patent application no. 201310479920 [Publ. no. CN 103611437 A].
Ogiwara et al (1981) Photosensitized grafting on polyolefin films in vapor and liquid phases Journal of Polymer Science: Polymer Letters Edition, 19, 457-462.
Schmolka (1973) Polyoxyethylene-polyoxypropylene aqueous gels U.S. Pat. No. 3,740,421.
Shentu et al (2002) Factors affecting photo-grafting on low density polyethylene Hecheng Suzhi Ji Suliao 19(3), 5-8.
Singleton et al (1993) Polymeric sheet International Application No. PCT/GB92/01245 (publ. no. WO 93/01622).
Tazuke and Kimura (1978) Surface photografting. I. Graft polymerization of hydrophilic monomers onto various polymer films Journal of Polymer Science: Polymer Letters Edition, 16, 497-500.
Wang et al (2006) Pluronic polymers and polyethersulfone blend membranes with improved fouling-resistant ability and ultrafiltration performance Journal of Membrane Science, 283, 440-447.
Xu and Yang (2000) Study on the mechanism of LDPE-AA vapor-phase photografting system Gaofenzi Xuebao (2000), 5, 594-598.
Yang and Ranby (1996a) The role of far UV radiation in the photografting process Polymer Bulletin (Berlin), 37(1), 89-96.
Yang and Ranby (1996b) Bulk surface photografting process and its applications. II. Principal factors affecting surface photografting Journal of Applied Polymer Science, 63(3), 545-555.
Yang et al (2014) Preparation and application of PVDF-HFP composite polymer electrolytes in LiNi_{0.5}Co_{0.2}Mn_{0.3}O2 lithium-polymer batteries Electrochimica Acta 134, 258-265.
Yao and Ranby (1990a) Surface modification by continuous graft copolymerization. I. Photoinitiated graft copolymerization onto polyethylene tape film surface Journal of Applied Polymer Science, 40, 1647-1661.
Yao and Ranby (1990b) Surface modification by continuous graft copolymerization. III. Photoinitiated graft copolymerization onto poly(ethylene terephthalate) fiber surface Journal of Applied Polymer Science, 41, 1459-1467.
Yao and Ranby (1990c) Surface modification by continuous graft copolymerization. IV. Photoinitiated graft copolymerization onto polypropylene fiber surface Journal of Applied Polymer Science, 41, 1469-1478.
Zhang and Ranby (1991) Surface modification by continuous graft copolymerisation. II. Photoinitiated graft copolymerisation onto polypropylene film surface Journal of Applied Polymer Science, 43, 621-636.

1) A water-wettable composite membrane comprising at least partially cross-linked poly(ethenol) adhered to a hydrophilicitized microporous sheet of polyolefin.

2) The membrane of claim 1 where the microporous sheet of polyolefin has been hydrophilicitized by grafting with a preformed polymer.

3) The membrane of claim 2 where the preformed polymer is poly(4-ethenyl benzene sulfonic acid) or a poloxamer of the structure:
HO(ethylene oxide)ₘ-(propylene oxide)ₙ-(ethylene oxide)ₘH
where m is in the range 15 to 25 and n is in the range 50 to 90.

4) The membrane of claim 3 where the polyolefin is poly(ethylene) or poly(propylene).

5) The membrane of claim 4 where the polyolefin is poly(ethylene).
